(19) United States
(12) Patent Application Publication
(10) Pub. No.: US 2017/0172340 A1
(43) Pub. Date: Jun. 22, 2017

(54) BEVERAGE DISPENSER

(71) Applicant: Access Business Group International LLC, Ada, MI (US)

(72) Inventors: David W. Baarman, Fennville, MI (US); Colin J. Moore, Grand Rapids, MI (US); Cody D. Dean, Grand Rapids, MI (US); Wei Yu, Guangdong (CN); Qiang Han, Shanghai (CN); Feng Wang, Guangdong (CN); Chang Biao Chai, Shanghai (CN); Xiao Juan Shen, Shanghai (CN); Yan Liu, Shanghai (CN)

(73) Assignee: Access Business Group International LLC, Ada, MI (US)

(21) Appl. No.: 15/127,070

(22) PCT Filed: Mar. 6, 2015
(86) PCT No.: PCT/US2015/019084

§ 371 Date: Sep. 19, 2016

Related U.S. Application Data
(60) Provisional application No. 61/969,317, filed on Mar. 24, 2014.

(51) Int. Cl. A47J 31/52; A47J 31/44; A47J 31/40; A47J 31/46

(52) U.S. Cl. CPC A47J 31/52; A47J 31/46; A47J 31/4492; A47J 31/40

(57) ABSTRACT

A beverage dispenser capable of preparing a variety of alternative types of beverages using different brewing parameters depending on the type of beverage. In one embodiment, the beverage dispenser is configured to use temperature, pressure and time parameters selected to provide optimal extraction for the type of beverage being prepared. In one embodiment, the beverage dispenser is intended to brew a variety of herbal teas with ingredients selected in accordance with traditional Chinese medicine. In one embodiment, the particle sizes of the various TCM ingredients are selected to provide optimized extraction in the beverage dispenser. The beverage dispenser may be configured to identify the type of beverage pod installed in the system and automatically prepare that beverage in accordance with optimized brewing parameters determined based on the ingredients and the particle sizes of those ingredients. The beverage dispenser may be capable of collecting user information and providing beverage recommendations.

### BACKGROUND OF THE INVENTION

The present invention relates to beverage dispensers, and more particularly to beverage dispensers capable of producing customized beverages.

There continues to be a significant desire for herbal tea, particularly in China and other Asian countries where many people utilize TCM's (Traditional Chinese Medicine) as a preventive health measure. One typical way to consume TCMs is to incorporate the TCMs into herbal tea. Perhaps the most common way to produce herbal tea, is to immerse the TCM herbal tea in a cup with hot water and wait until a tolerant temperature to drink. The TCM herbal tea ingredients can be typically be used more than once. So, it is common to refill the cup containing the TCM ingredients 3-5 times in one day. This is usually preceded by a diagnosis either through a TCM doctor or by self-diagnosis. The diagnosis may suggest the use of a variety of different ingredients, such as plant extracts and/or other TCM ingredients, in varying amounts. In addition to TCM ingredients, it may be desirable to include other functional ingredients into the herbal tea. For example, it may be desirable to add vitamins, minerals, nutritional supplements and/or other functional components. It may also be desirable to add additional ingredients that impact flavor, consistency or other aesthetic aspects of the herbal tea.

There are a wide variety of commercially-available beverage dispensers. These devices are commonly used to brew coffee, tea and other beverages. Although available in a wide variety of designs and configurations, many conventional beverage dispensers produce beverages from pods or cartridges that contain the ingredients used to brew or otherwise producing the beverage. The pods can be installed in the dispenser to provide the ingredients to produce beverages. In some cases, the pods are single use components that provide the ingredients for a single beverage serving. In other cases, the pods include sufficient ingredients to allow the production of more than one serving. As an alternative to pods or cartridges, other conventional dispensers include storage compartments in which ingredients can be stored in bulk. For example, a beverage dispenser intended to produce coffee and hot chocolate may include storage bins for coffee beans and powered hot chocolate mix.

Although some beverage dispensers are capable of producing herbal teas, there remains a need for a beverage dispenser that adequately provides for a wide variety of herbal tea recipes and that is capable of dramatically increasing tea brewing time.

### SUMMARY OF THE INVENTION

The present invention provides a beverage dispenser with improved functionality and reduced brewing time. The beverage dispenser is configured to produce customizable herbal teas, as well as other beverages. The beverage dispenser includes a brewing chamber in which the ingredients may be subjected to a diluent, such as water, under variable conditions. In one embodiment, the dispenser is capable of varying the time, pressure and/or temperature in the brewing chamber. In one embodiment, the beverage dispenser is configured to prepare beverages from ingredient pods having ingredients with particle sizes selected to provide reduced preparation time without undesirably affecting the produced beverage.

In one embodiment, the beverage dispenser generally includes a housing containing a water tank, a pump, a heater, a brewing chamber, an outlet and a drain. The dispenser includes a flow network including a plurality of passages and a plurality of valves for controlling the flow of liquid through the system. The beverage dispenser includes a controller configured to control operation of the system, including operation of the pump, heater and various valves to produce the desired beverage in accordance with a variety of alternative recipes. In one embodiment, the beverage dispenser is capable of varying the pressure and/or temperature of the brewing chamber as desired for each type of beverage. In one embodiment, the beverage dispenser is capable of pre-soaking the beverage ingredients with water at the desired temperature and pressure settings and/or softening the beverage ingredients using steam at the desired temperature and pressure.

In one embodiment, the brewing chamber is configured to receive a pod (e.g. a container or cartridge holding beverage ingredients). The pod may be placed in the brewing chamber where it remains during beverage production or the pod may be opened and the ingredients may be dumped from the pod into the brewing chamber. The pod may be a single use container holding ingredients appropriate for producing a single serving of the beverage. However, the pod may contain sufficient ingredients for multiple servings, if desired. The pod may be disposable or may be refillable, as desired. As an alternative, the dispenser may include one or more storage receptacles that hold beverage ingredients. For example, the dispenser may include a separate storage receptacle for each potential beverage ingredient. As a further alternative, the dispenser may be configured to receive ingredients from pods and/or one or more storage receptacles. For example, the primary beverage ingredients may be included in a pod and one or more additive ingredients may be contained in storage receptacles. The additive ingredients may include optional functional ingredients, such as vitamins, minerals, nutritional supplements and/or other functional components, and/or aesthetic ingredients that impact flavor, consistency or other aesthetic aspects of the beverage.

In one embodiment, the beverage dispenser is capable of pre-soaking and/or steam softening select ingredients. For example, the controller may be configured to inject water, steam or other ingredients into the brewing chamber to wet, soak and/or soften the ingredients. The pre-soak and/or steam-softening parameters may vary from beverage-type to beverage-type and/or from application to application. For example, the system may vary the amount of liquid or steam injected, the type of liquid injection, the amount of pre-soak or steam-softening time, the pre-soak or steam-softening pressure and the pre-soak or steam-softening temperature. The characteristics of the pre-soak and steam-softening may also vary over time. For example, the temperature, pressure and/or amount of liquid injected into the brewing chamber may vary during a single pre-soak or steam-softening event.

In one embodiment, the beverage dispenser includes information system capable of obtaining information from a pod or cartridge loaded into the brewing chamber. The type or types of information available from the pod may vary from application to application. In one embodiment, the information system is configured to obtain information that identifies the type of beverage or beverages that can be produced from the pod. In one embodiment, the information system is capable of obtaining brewing instructions from the pod. In one embodiment, the information system is capable of obtaining other types of information, such as the expiration date of the ingredients contained in the pod.

In one embodiment, the identification system is configured to read data bits provided on a data tab of a pod or other type of beverage cartridge. The data bits may be represented by the presence or absence of holes or other physical variations in select locations on the data tab. The data bits may additionally or alternatively be represented by printed content on the data tab, such as color variations located at select locations on the data tab. The data bits may be arranged in a regular array or grid.

In one embodiment, the data bits are represented by holes in the data tab, and one of the holes may be used as a locator to ensure proper alignment between the data tab and the data reader. In this embodiment, the locator hole may be fitted over a locating pin. Alternatively, the data tab may include a locator pin that is fitted into a locating hole. In one embodiment, the data tab is disposed outside the high pressure sealing area so that the data tab and data reader are not subjected to the environment within the brewing chamber.

In one embodiment, the information system includes an optical data reader configured to read data represented by holes in the data tab. In this embodiment, the information system may include a light source located on one side of the data tab and a plurality of photosensors on the opposite side. Each photosensor may be uniquely positioned beneath a specific data bit so that the presence or absence of the hole can be determined based on whether or not the photosensor senses light from the light source. The light source may be an LED and a light pipe may be positioned between the LED and the data tab to provide sufficient light distribution over all of the data bits. The photosensors may be photodiodes, LEDs or essentially any other component capable of providing an output that varies based on the presence or absence of light.

In this embodiment, the data bits may be configured to provide the information system with a pod identification number. The controller may be configured to obtain the preparation parameters for the beverage based on the identification number. For example, the controller may include a look-up table with the preparation parameters and the identification number obtained from each pod may be a key to the look-up table to allow the controller to obtain the parameters for that pod. As an alternative, the data bits may present an encoded set of beverage preparation parameters. For example, the values of the various data bits may be selected to specify the beverage preparation parameters.

In one embodiment, the pods include machine readable information that can be read by the information system. In one embodiment, the pods are capable of being manipulated by the user to allow the user to provide information to the beverage dispenser. For example, the pods may include one or more user-adjustable data bits or flags that allow the user to customize the beverage or the associated preparation process. The user-adjustable bits may be varied to allow a user to define essentially any characteristic of the beverage, such as strength of brew, brewing temperature and/or additive ingredients. As a few examples, the pod may include a user-adjustable data bit that defines whether the user wants the beverage hot or cold, whether the user mays the beverage strong or mild, whether the user wants caffeine (or other additives) or whether the user would like an expedited or standard preparation process. In one embodiment, the user-adjustable bits are perforated portions of the data tab that can be broken out by the user to create a hole that can be sensed by the data reader.

In one embodiment, the beverage dispenser is configured to brew a plurality of TCM herbal teas. The ingredients for a plurality of TCM herbal teas may be available in specially configured pods. In one embodiment, the fire removal drink, damp-heat eliminator drink, stasis eliminator and beauty enhancer drink, mental-fatigue removal drink, and/or tonifying kidney anti-premature-aging drink.

In one embodiment, the beverage dispenser includes a user assistance system. The user assistance system may be capable of collecting information about a user and providing beverage recommendations. The user assistance system may be part of a larger data collection system that collects information a variety of useful information from and about the user. For example, the user assistance system may be part of a larger system that collects information about a user's physical activities and food/beverage consumption. It may also collection information about user preferences and about how a user is feeling at any given time. The user assistance system may be capable of analyzing the collected information and providing appropriate beverage recommendations, including beverage type and beverage additives. For example, the user assistance system may assess diet, such as food and beverage consumption, including alcohol consumption, and recommend a beverage type and/or functional additives to be included in a beverage. The user assistance system may also consider user-supplied information about how the user is feeling (e.g. stress level, general wellness, perceived energy level) or analyze sleep data collected about the user in making recommendations regarding beverage additives. The user assistance system may also review historical information when making a recommendation, such as a user's prior response to a given beverage formulation. In use, the user assistance system is capable of suggesting beverage types and/or beverage additives based on essentially any potentially relevant data this is either collected automatically by various monitoring systems or that is input into the system by the user.

In one embodiment, the user assistance system is capable of communicating with a personal device carried or worn by the user. In one embodiment, the personal device and user assistance system are capable of communication electronically, for example, via Bluetooth, WiFi or other wired or wireless communication systems. The personal device may carry the user's identification, as well as the user's preferences.

The present invention provides a beverage dispenser that is highly customizable and capable of brewing a wide variety of beverages, including customized TCM herbal teas. The beverage dispenser may be capable of adjusting the time, temperature and pressure used during beverage preparation, and through that functionality may be capable of producing beverages, such as coffee and TCM herbal teas, much more quickly than conventional brewing/preparation techniques. The beverage dispenser may also be capable of pre-soaking the ingredients with steam or cold water to increase extraction rates and reduce overall brewing/preparation time. The beverage dispenser is capable of producing a variety of TCM herbal teas formulated to address some of the most common ailments as determined by TCM, such as a “fire removal” formula, a “damp-heat eliminator” formula, a “beauty builder” formula, a “fresh” formula and a “kidney nourishment” formula. The particle sizes of the ingredients of the various formulas may be selected to optimize brewing time without unacceptably impacting flavor or effectiveness of the TCM herbal tea. The use of an information system in some embodiments allows the system to recognize the pod and implement the appropriate brewing procedures without the need for user intervention. The user assistance system of some embodiments allows the system to provide meaningful beverage recommendations to the user. The ability of the user assistance system to interact with other health-related automated systems may permit more meaningful and comprehensive recommendations.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a schematic representation of a beverage system showing certain information that may be associated with a specific beverage formulation.

FIG. 2 is a schematic representation of a user interacting with a beverage system showing certain data that may be maintained by the system in connection with a single use of the system.

FIG. 3A is a perspective representation of the beverage dispenser supporting a pot.

FIG. 3B is a perspective representation of the beverage dispenser supporting a cup.

FIG. 4A is a perspective representation of an alternative beverage dispenser supporting a pot.

FIG. 4B is a perspective representation of the alternative beverage dispenser supporting a cup.

FIG. 5A is a perspective representation of a second alternative beverage dispenser supporting a cup.

FIG. 5B is a perspective representation of the second alternative beverage dispenser supporting a pot.

FIG. 6 is a table containing recommendation history, the symptom tracking and the feedback flag status showing compliance.

FIG. 7A is a schematic representation of a beverage dispenser.

FIG. 7B is a schematic representation of an alternative beverage dispenser.

FIG. 8 is a flow chart showing a functional block diagram of a brewing process that can be implemented using the beverage dispenser of FIG. 7A.

FIG. 9 is a schematic representation of the recommendation and feedback process.

FIG. 10A is a schematic representation showing software components that may be implemented on a portable electronic device in one embodiment.

FIG. 10B is a schematic representation showing interaction of the device through the internet and through low energy Bluetooth, for example, for updates and links to recommendations.

FIG. 11 is a flowchart of one embodiment of the recommendation process

FIG. 12 is a flowchart of the compliance tracking and the inventory tracking and order process of one embodiment.

FIG. 13 shows examples of several methods used to log user identification with or without an electronic device for communications.

FIG. 14-16 collectively form a table containing data relating to a plurality of TCM formulations.

FIG. 17A is a side elevational view of one embodiment of a pod.

FIG. 17B is a top plan view of a pod.

FIG. 17C is a top plan view of the pod with a portion highlighted to show the sealing area.

FIG. 18 is a schematic representation of a pod showing one implementation of binary bit positions and a plurality of different binary codes implemented as holes in a tab on a pod.

FIG. 19 is a representational diagram of an information system for obtaining information from a pod.

FIGS. 20A-C are schematic representations of alternative beverage systems that utilize pills, powders or discs of TCM that can be loaded into the machine.

FIG. 21 is a schematic representation of a beverage system allowing user modification.

FIG. 22 is a schematic representation of an alternative beverage system capable of identifying and measuring different ingredients poured into the beverage dispenser.

FIG. 23 is a schematic representation of a personal device configured to allow personalization.

FIG. 24 is an alternative beverage dispenser capable of being couple to a water treatment device.

FIG. 25 is a flow chart of a brewing process.

### DESCRIPTION OF CURRENT EMBODIMENTS

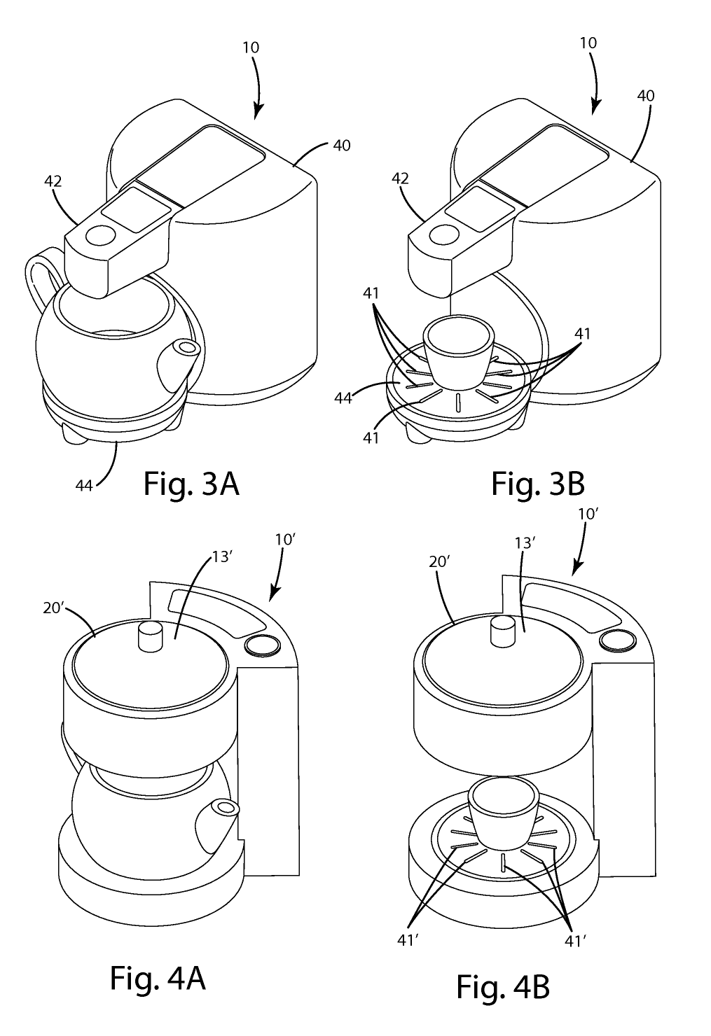

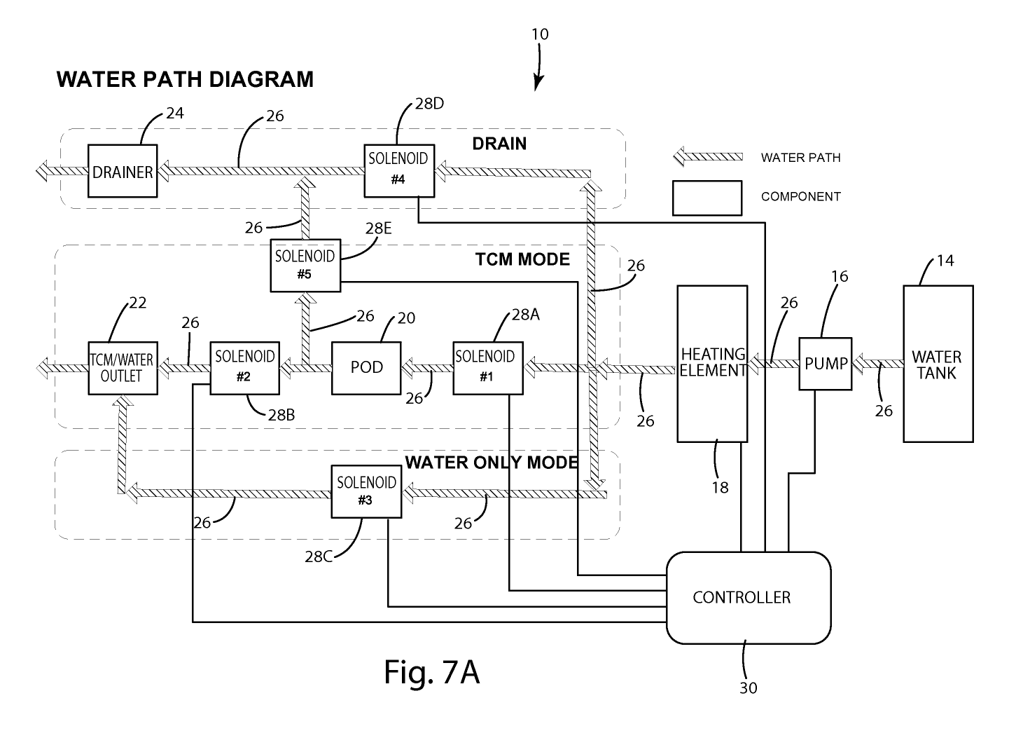

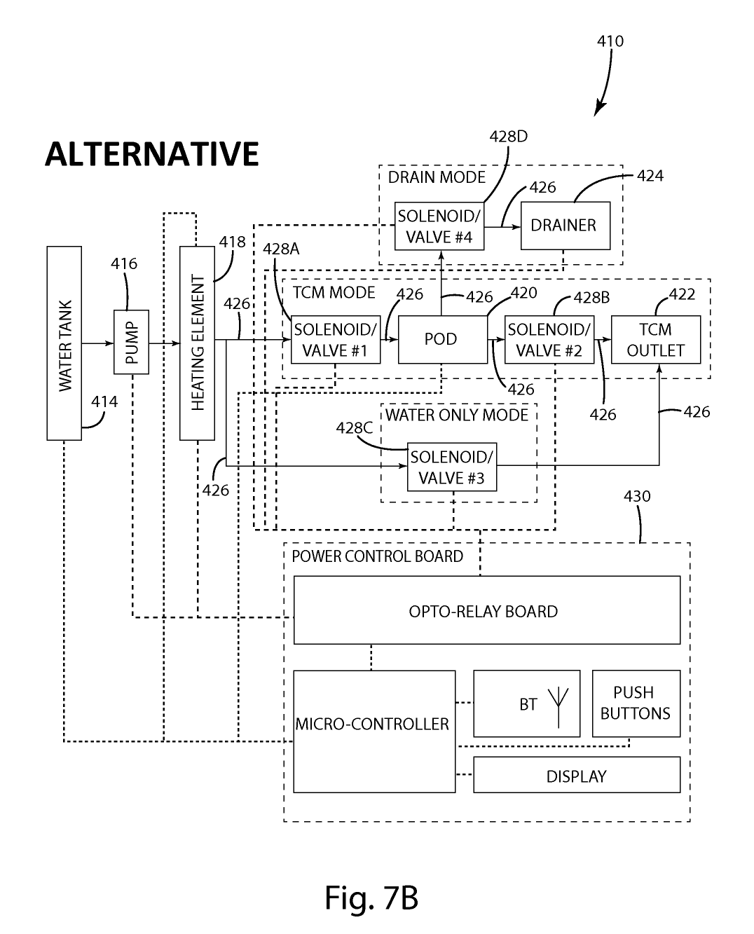

A beverage dispenser in accordance with an embodiment of the present invention is shown in FIGS. 3 and 7A, and generally designated 10. The beverage dispenser 10 generally includes a housing 12 containing a water tank 14, a pump 16, a heater 18, a brewing chamber 20, an outlet 22 and a drain 24. The dispenser includes a flow network including a plurality of passages 26 and a plurality of valves 28a-e for controlling the flow of liquid through the system. The beverage dispenser 10 includes a controller 30 configured to control operation of the system, including operation of the pump 16, heater 18 and various valves 28a-e to produce a beverage in accordance with a variety of alternative recipes. The controller 30 is capable of varying the pressure and/or temperature of the brewing chamber 20 in accordance with a beverage recipe. More specifically, the controller 30 may control operation of the pump 16, the heater 18 and the valves 28a-e to prepare beverages under different parameters. In the illustrated embodiment, the beverage dispenser 10 is particularly well-suited for use in brewing herbal teas having ingredient blends selected in accordance with traditional Chinese medicine (“TCM”). To facilitate rapid brewing of TCM herbal teas, the TCM ingredients are provided at optimal particle size, and the controller 30 is configured to brew the herbal tea at enhanced pressure and temperature for less time than would be required at conventional brewing pressure and temperature. Further, the controller 30 may be configured to pre-soak the herbal tea ingredients at enhanced temperature and pressure, such as through the introduction of steam into the brewing chamber prior to brewing.

The beverage dispenser 10 may function as a beverage dispenser that is customizable by or for the user. The capabilities of the system allow each ingredient used in the pods to be specifically extracted. This allows extractions to be made differently for a pot versus a cup. It also allows customization of brewing parameters at the control of the beverage dispenser. For example, the brewing processes may be varied to allow adjustment of the time, temperature and pressure at the control of the beverage dispenser. This method allows faster production of the desired mixtures based on expected use and volumes required.

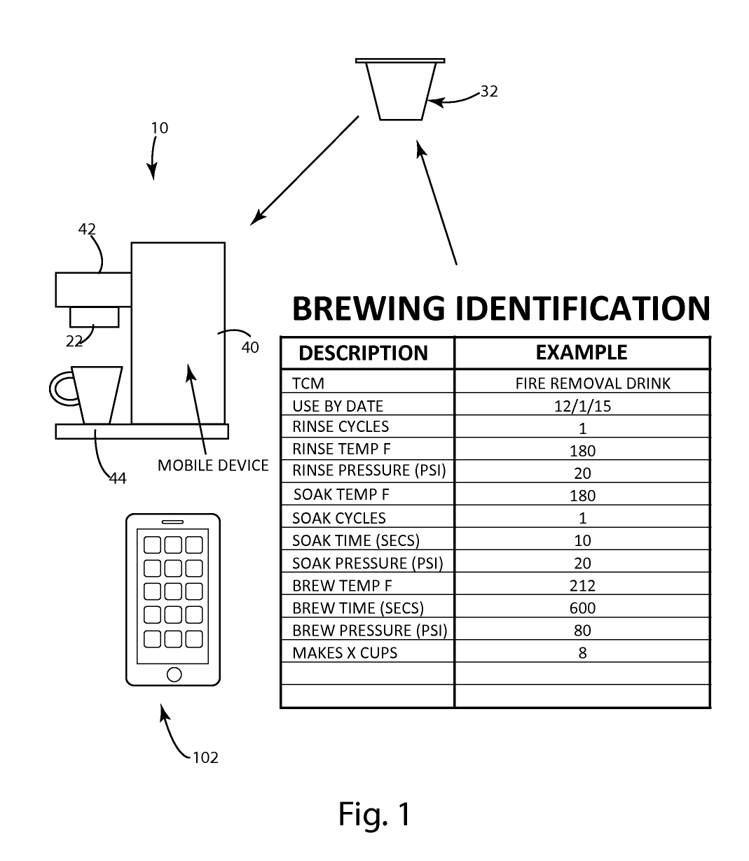

The beverage dispenser 10 may be capable of communicating with other electronic devices. For example, as shown in FIG. 1, the beverage dispenser 10 may be capable of communicating with a personal device 102, such as a smartphone. The personal device 102 may be used to identify a user, and to function as a user interface with the beverage dispenser 10. As a user interface, the personal device 102 may be used to directly control the beverage dispenser 10, for example, by directly dictating brewing parameters or beverage customizations (e.g. additives), or it may indirectly control the beverage dispenser 10 by providing the beverage dispenser 10 with information that may used to automatically determine the brewing parameters or beverage customizations.

The beverage dispenser 10 may be part of a larger system (or network) of products that collect information about user activities, such as diet, exercise and other factors that may be relevant to health and well-being. By collecting this information, the system may be able to assist a user in making choices that improve health and well-being. It is well known that by tracking consumption of food, water, and nutrition and activity, a better picture of health needs can be obtained. This dispenser 10 represents one aspect of this system but helps to build one element of a larger view of a personal health plan. The beverage dispenser 10 may be configured to communicate with the Internet or other system components using wireless communications, such as WiFi or low energy Bluetooth. The communications capability may allow the beverage dispenser to transmit and/or receive personal health information for a user. The communications capability may also enable the beverage dispenser 10 to connect to the internet for reordering of pods or other consumables.

The beverage dispenser 10 may also implement a “recommender” that asks questions and/or collects information about a user (or other relevant factors) to derive a possible beverage recommendation. The recommender can be linked to an ordering system (e.g. automated system for ordering recommended beverage pods or beverage ingredients) or a consumption system (e.g. automated system for communicating the recommendation to the user and/or the beverage dispenser). It also enables tracking of the consumption and feedback on the efficacy of the consumed beverage, which in turn enables tracking the statistical efficacy of various recommendations over time and large communities.

Each pod 32 may be provided with an identifier that is capable of identifying the type of beverage or other information that might be relevant to the brewing process or to functionality associated with the larger network of health and well-being products. For example, the identifier may include information that allows the beverage dispenser 10 to identify the specific beverage being produced and/or it may include information that defines the brewing parameters for the beverage. The identifier may be incorporated into the pod 32 using a wide variety of alternative techniques. For example, the identifier may be incorporated into an RFID chip integrated into each pod 32. In the illustrated embodiment, the dispenser 10 uses a series of optical sensors to read the binary value of the pod tab. For example, the optical sensors may look for the presence or absence of holes at specific locations in the pod tab, and the presence or absence of holes may represent data bits (e.g. “0” or “1”). In the illustrated embodiment, the dispenser 10 then uses a lookup table to load the values (e.g. brewing parameters) for that pod into the system. The light coded binary value is linked to a table that can be redefined using the digital interface to the internet allowing updates to this table as new formulas are released.

It should also be noted that the RFID or coded pod identifier can be used as an anti-counterfeit identification, if desired. Anti-counterfeit identification may be desirable to protect consumers from beverage pods that do not include manufacturer approved materials. As an alternative to incorporating the anti-counterfeit functionality into the pod identifier, the pod may include a separate number/code for anti-counterfeit purposes. The code can, for example, be an encrypted serial number. If the code is determined to be a false code or is not present, the unit determines the pod is a counterfeit. That information can be displayed on the display and/or may disable the unit from functioning with that pod.

### Beverage Dispenser

As noted above, a beverage dispenser 10 in accordance with an embodiment of the present invention is shown in FIGS. 3 and 7A. The beverage dispenser 10 generally includes a housing 12 containing a water tank 14, a pump 16, a heater 18, a brewing chamber 20, a beverage outlet 22 and a drain 24. The dispenser includes a flow network including a plurality of passages 26 and a plurality of valves 28a-e for controlling the flow of liquid through the system. The beverage dispenser 10 includes a controller 30 configured to control operation of the system, including operation of the pump 16, heater 18 and various valves 28a-e to produce a beverage in accordance with a variety of alternative recipes. The water tank 14 may be essentially any vessel or other type of reservoir capable of storing the desired volume of water. In some applications, the water tank 14 may be removable from the housing 12 so that it can be carried to a water source (e.g. a sink) for filling. In other applications, the water tank 14 may be fixed and it may be filled by bringing water to the dispenser 10. Although the tank 14 is contained in the housing 12 in the embodiment of FIGS. 3A-B, the tank 14 may alternatively be external to the housing 12.

Referring now to FIGS. 3A-B, the housing 12 may generally include a main portion 40, a beverage discharge portion 42 and a receptacle support portion 44. The main portion 40 may be configured to house the tank 14, pump 16, heater 18, valve 28a-e and controller 30. The beverage discharge portion 42 may include the brewing chamber 20 and the beverage outlet 22. The receptacle support portion 44 may provide a surface for supporting a cup, pot or other receptacle that receives the beverage as it is dispensed from the beverage dispenser 10. As noted above, the beverage dispenser 10 includes a drain 24, which allows water to be expelled from the system. For example, in some applications, it may be desirable to flush the brewing chamber 20 or one or more of the flow passages 26 between brewing operations. As another example, it may be desirable to discharge water used in pre-soaking or steam-softening the ingredients. In the illustrated embodiment, the drain 24 is positioned in a storage reservoir (not shown) disposed with the receptacle support portion 44 beneath a perforated cover plate 46. In this configuration, the storage reservoir can hold liquid that spills onto the support surface and liquid that is discharged through the drain 24.

The beverage dispenser 10 may use essentially any pump 16 capable of providing the desired pressure and flow rate, such as a vibration pump, a rotary pump or a reciprocating pump. In the illustrated embodiment, the pump 16 is a generally conventional vibration pump capable of producing 8 bar at a flow rate of 50 ml liters per minute. The pressure and flow rate of the pump may, however, vary from application to application depending on the needs of the desired brewing parameters. For example, in typical applications, the pressure may range from 1 bar to 10 bar, and the flow rate may range from 45 ml to 170 ml per minute. In the illustrated embodiment, the pump 16 is positioned between the tank 14 and the heater 18 so that the pump 16 is not required to accommodate heated water. In alternative embodiments, the pump 16 may be downstream from the heater 18 in which case it may be necessary for the pump 16 to be capable of moving water at or above 100° C. In the illustrated embodiment, the pump 16 is configured to work on mains power, such as 220V/50 Hz and 110V/60 Hz. The pump 16 may, however, be selected to work with other types of power.

The beverage dispenser 10 includes a plurality of flow passages 26 and a plurality of valves 28a-e that are operated by the controller 30 to control the flow of water through the beverage dispenser 10. The flow passages 26 may be essentially any form of tubing or functionally equivalent components capable of withstanding the temperature and pressure generated within the system. In the illustrated embodiment, the passages 26 are defined by sections of tubing that are joined by suitable connectors. As with the tubing, the dispenser 10 includes connectors capable of withstanding the temperature and pressure generated within the system. As an alternative, one or more of the flow passages may be implemented in the form of a manifold. The valves 28a-e may be essentially any valves capable of being opened and closed by the controller 30 as appropriate to implement the desired brewing procedures. In the illustrated embodiment, the valves 28a-e are conventional solenoid valves that operate on mains power. If desired, the beverage dispenser 10 could alternatively include valves configured to operate on other types of power, such as 12 VDC.

As noted above, operation of the beverage dispenser 10 is controlled by a controller 30. The controller 30 is capable of varying the pressure and/or temperature of the brewing chamber 20 in accordance with a beverage recipe. More specifically, the controller 30 may control operation of the pump 16, the heater 18 and the valves 28a-e to prepare beverages under different parameters (as described in more detail below). In one embodiment, the controller 30 is capable of identifying the type of pod installed in the beverage dispenser 10 and controlling the beverage dispenser 10 in accordance with brewing procedures specific to that type of beverage. For example, the controller 30 may drive the pump 16, heater 18 and valves 28a-e to prepare the beverage in accordance with the type of beverage being prepared. The beverage preparation parameters may be contained in a memory unit accessible to the controller 30. Alternatively, the beverage preparation parameters may be encoded into machine-readable information that is presented with the pod. In these alternative embodiments, the controller 30 may read the preparation parameters from the pod.

In the illustrated embodiment, the controller 30 is configured to control operation of the pump 16, heater 18 and valves 28a-e using generally conventional switching elements (not shown), such as triacs, FETs or relays. In this embodiment, the switching elements are triacs. Although variable, the triacs for the pump 16 and the valves 26a-e may have a 12-amp rating, and the triac for the heater 18 may have a 25-amp rating. In this embodiment, the controller 30 includes a plurality of general-purpose input/output (“GPIO”) pins capable of driving the switching elements. The controller 30 may also include a plurality of A/D pins (not shown) that allow the controller 30 to receive input from sensors and other external devices or components. For example, in this embodiment, the controller 30 may receive input from a temperature sensor (not shown) via an A/D pin to allow the controller 30 to control temperature. As another example, the controller 30 may be configured to receive input from the information system, such as the photosensors, via one or more A/D pins (described in more detail below). To facilitate wireless communication, the controller 30 may have integrated wireless communications capabilities or have the ability to interface with a separate wireless communication system. The communications protocol may vary, but WiFi and/or low energy Bluetooth communication may be implemented in the illustrated embodiment.

In the illustrated embodiment, the beverage dispenser 10 is particularly well-suited for use in brewing herbal teas having ingredient blends selected in accordance with traditional Chinese medicine (“TCM”). To facilitate rapid brewing of TCM herbal teas, the TCM ingredients are provided at optimal particle size, and the controller 30 is configured to brew the herbal tea at enhanced pressure and temperature for less time than would be required at conventional brewing pressure and temperature. Further, the controller 30 may be configured to pre-soak or steam-soften the ingredients at enhanced temperature and pressure, such as through the introduction of water or steam into the brewing chamber prior to brewing.

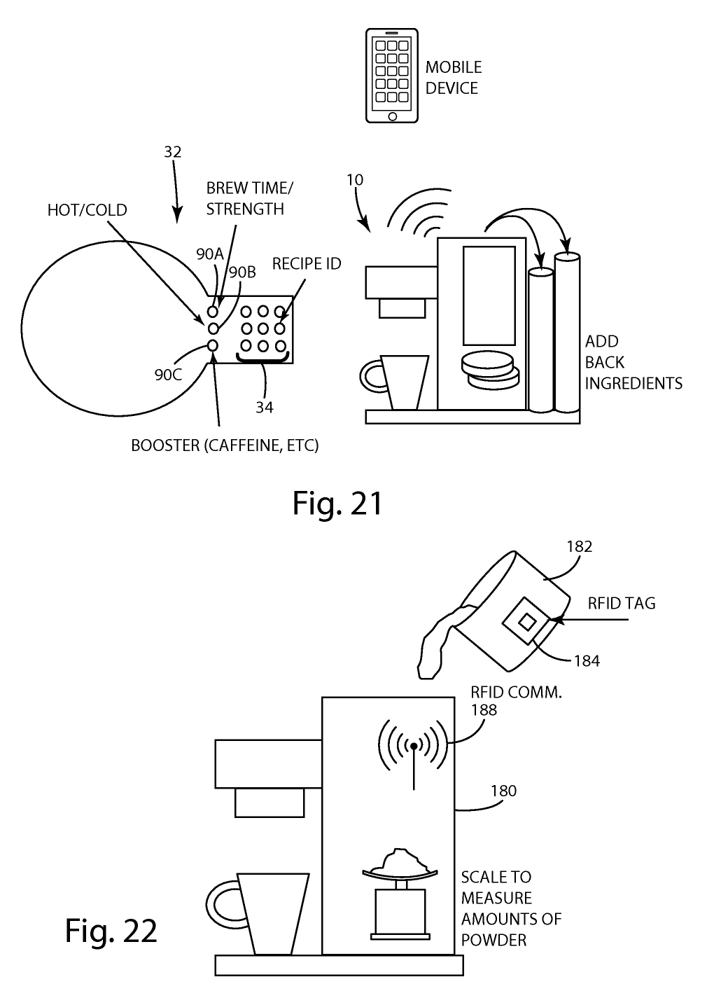

In the illustrated embodiment, the brewing chamber 20 is configured to receive a pod 32 that contains the beverage ingredients. The pod 32 may be essentially any type of container or cartridge capable of holding beverage ingredients. The pod 32 may be placed in the brewing chamber 20 where it remains during beverage production or the pod 32 may be opened and the ingredients may be dumped from the pod 32 into the brewing chamber 20. The pod may be a single use container holding ingredients appropriate for producing a single serving of the beverage. However, the pod may contain sufficient ingredients for multiple servings, if desired. The pod may be disposable or may be refillable, as desired. As an alternative, the dispenser may include one or more storage receptacles that hold beverage ingredients. For example, the dispenser may include a separate storage receptacle for each potential beverage ingredient. As a further alternative, the dispenser may be configured to receive ingredients from pods and/or one or more storage receptacles. For example, the primary beverage ingredients may be included in a pod and one or more additive ingredients may be contained in storage receptacles. The additive ingredients may include optional functional ingredients, such as vitamins, minerals, nutritional supplements and/or other functional components, and/or aesthetic ingredients that impact flavor, consistency or other aesthetic aspects of the beverage. In embodiments that have the ability to provide additive ingredients, the ingredients may be provided in the form of liquid concentrates that are stored in separate storage vessels. The beverage dispenser may include one or more pumps that are capable of injecting additive ingredients into the brewing chamber and/or into the beverage outlet 22. For example, as shown in FIG. 21, the beverage dispenser 510 may include two reservoirs 502a-b that include additives (also referred to as “add-back” ingredients) that can be used to supplement the ingredients contained in pods 32. Each reservoir 502a-b may be configured to receive a liquid concentrate and may have a dedicated pump (not shown) for delivering the desired amount of concentrate to the brewing chamber 20 or to the beverage outlet, as desired. As shown, a personal device 102, such as a mobile phone, may be used by the user to direct the beverage dispenser 10 to include the additives.

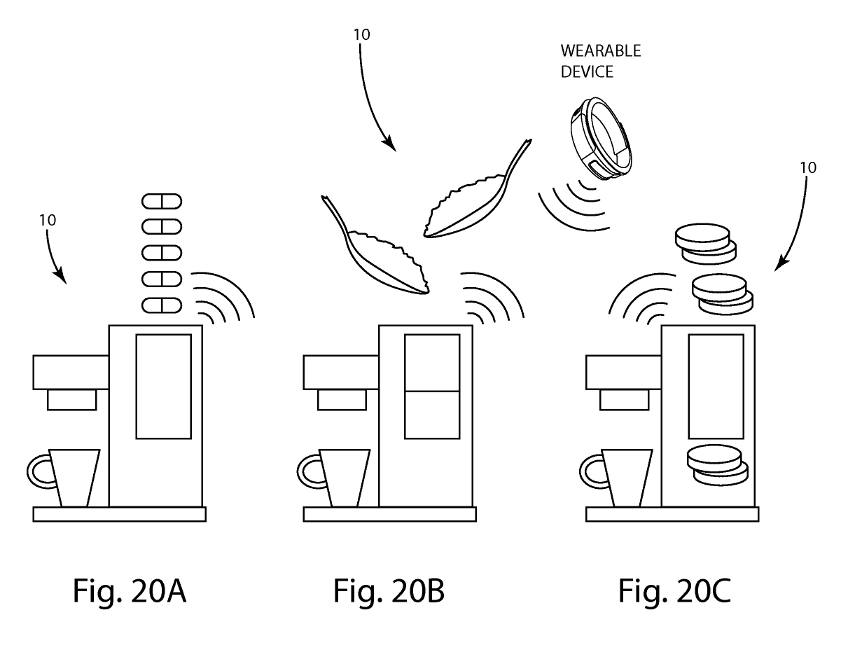

FIGS. 20A-C shows a variety of alternative configurations. In FIG. 20A, the beverage dispenser 10 uses highly concentrated pills for ingredients. In FIG. 20B, the system uses loose powders that can be loaded into the dispenser 10. In FIG. 20C, the system uses discs that can be loaded into the beverage dispenser 10. With more ingredients on hand, there is a possibility for a greater range of recommendations. The use of pills, loose powder or discs may allow for greater flexibility in preparing unique combinations of ingredients. With these alternatives, a user could, for example, require a certain TCM but need more of a certain root because they have more allergies or have a cold. Extra herbs can be added to the brew to create a combination totally unique to an individual. If the biometrics of a person are being monitored by a wearable device, these output metrics can be sent to the beverage dispenser and based on these the dispenser can go through an iteration process where it starts changing ingredients until the optimal outputs of the user are reached. The dispenser 10 may change full recipes or it may vary individual components of a recipe and/or the amounts of each component.

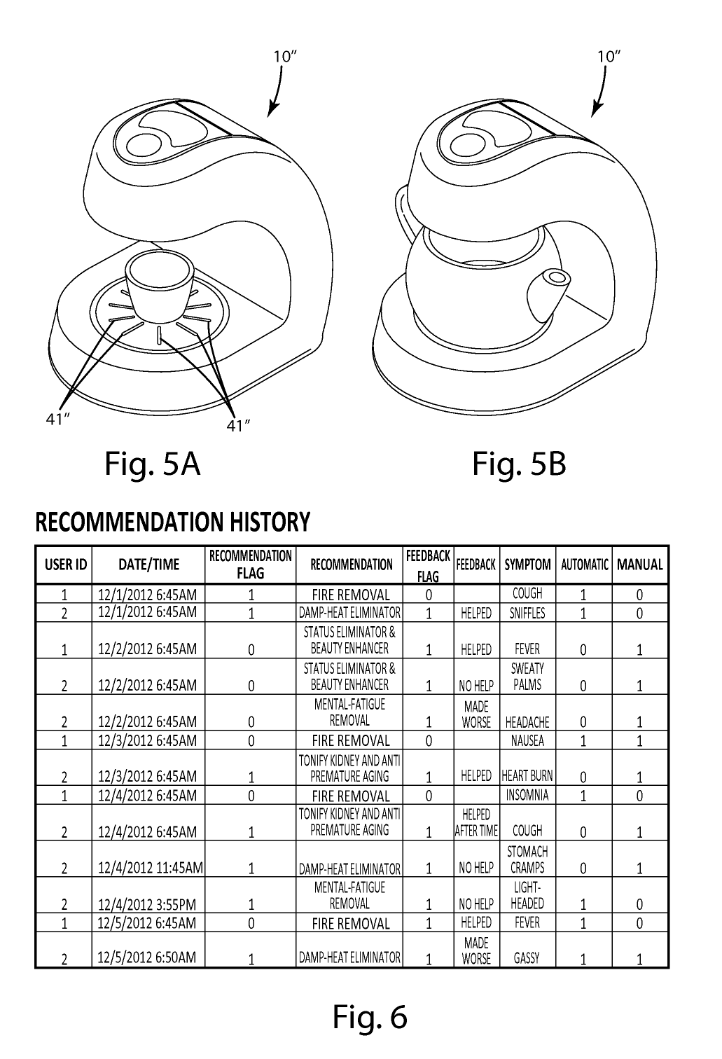

It should be noted that the beverage dispenser of FIGS. 3A-B is merely exemplary and that the design and configuration of the beverage dispenser may vary from application to application as desired. For example, FIGS. 4A-B and 5A-B show alternative beverage dispensers. Although not described in detail, these alternative embodiments may include essentially the same or similar functional component, and may operate in much the same manner as the beverage dispenser of FIGS. 3A-B. FIGS. 4A-B shows an alternative beverage dispenser 10′ that does not use the same type of pods associated with the beverage dispenser 10 of FIGS. 3A-B. In this alternative embodiment, the beverage ingredients may be provided loosely or they may be provided in a bag-type pod (e.g. akin to a tea bag). The brewing chamber 20′ is disposed beneath cover 13′ and the ingredients may be loaded into the brewing chamber 20′ by removing the cover and adding loose ingredients or by inserting a pod. FIGS. 5A-B shows a beverage dispenser 10″ with different styling. The beverage dispenser 10″ of FIGS. 5A-B may receive pods as described in connection with the beverage dispenser 10 of FIGS. 3A-B, or it may receive loose ingredients or ingredients provided in a bag-type pod as described in connection with the beverage dispenser 10′ of FIGS. 4A-B.

The beverage dispenser may be capable of brewing different amounts of a beverage, such as a single serving to fill a cup or multiple servings to fill a pot. Although the brewing volume may be manually set by the user, the beverage dispenser may include an automated system for determining the volume to be brewed. In embodiments of this nature, the beverage dispenser may be configured to automatically set the brewing volume based on the size of the receptacle placed on the beverage dispenser. For example, the beverage dispenser may include an optical sensor array (e.g. array of photodiodes) disposed in the base to determine the diameter of a receptacle placed on the base. When the optical sensor array detects a receptacle with the diameter of a cup, the beverage dispenser will be set to brew a single serving. When the optical sensor array detects a receptacle with the diameter of a pot, the beverage dispenser will be set to brew multiple servings. This functionality may be implemented in controller 30 or using a separate controller. In the embodiments shown in FIGS. 3A-B, 4A-B and 5A-B, the surface of the base may include a plurality of radially symmetric slots 41 (See e.g. 3B and 5A) that may allow ambient light to pass from above the base to array of optical sensors (not shown) disposed below the surface. In operation, a receptacle placed on the surface will affect which optical sensors receive ambient light and this information may be used by the beverage dispenser controller to set the brewing volume. Although the sensor array may vary from application to application, the array may include a set of three optical sensors (e.g. photodiodes) positioned toward the center of the base where they will all three will be covered by a cup or pot properly placed on the surface of the base and an outer set of three optical sensors that are arranged radially outward from the inner set at a distance from the center selected so that they will be covered by a pot, but not by a cup, properly placed on the surface of the base. The system may include lightpipes (not shown) to allow the light to be gathered through the slots and directed to the photodiodes. With this system, the presence of a properly positioned receptacle can be determined by the absence of light reaching the inner set of optical sensors. The system can discriminate between a cup and a pot based on whether the outer set of optical sensors is covered by the receptacle. The system may also be able to recognize an error condition based on the output of the sensor array. For example, the system may recognize when a receptacle is not centrally positioned on the base or it may recognize when an item not matching the shape of a cup or pot is placed on the base. The beverage dispenser may be configured so that it will not produce a beverage when an error condition exists. The system need not be fully automated, if desired. For example, if the system recognizes a cup, it may automatically set the brewing volume to a single serving. However, if the system recognizes a pot, it may prompt the user to set the brewing volume (e.g. from a single serving up to the maximum capacity of the receptacle). This will allow a user to produce a single serving in a pot when desired.

Another alternative embodiment is shown in FIG. 24. In this embodiment, the beverage dispenser 10″′ has been reduced in size and is configured to fit on the auxiliary faucet F of a water treatment system W. The beverage dispenser 10″′ of this embodiment receives treated water from the water treatment system W and therefore does not require a separate water tank or a separate pump. In this embodiment, the water treatment system W also includes an integrated water heater (not shown). Accordingly, the beverage dispenser 10″′ does not require a separate heater. In this embodiment, the beverage dispenser 10″′ includes a brewing chamber (not shown) that is capable of receiving pods 32″′ and includes flow passages that allow heated water received from the water treatment system W to be passed through a pod 32″′ installed in the brewing chamber. In this embodiment, the end of faucet beverage dispenser 10″′ is primarily intended for brewing beverages with hot water at line pressure. The end of faucet beverage dispenser may include additional and/or alternative components. For example, the end of faucet beverage dispenser may include a miniature pump (not shown) that allows brewing to occur at elevated pressure. As another example, the end of faucet beverage dispenser may include an integrated heater (not shown). The integrated heater may be configured to heat the water when the water treatment system W does not include a heater or it may be configured to provide additional heat even when the water treatment system W includes a heater.

In the illustrated embodiment, the beverage dispenser 10 includes an information system 80 that is capable of obtaining information from a pod 32 that is loaded into the brewing chamber 20 (See FIG. 19). The type or types of information available from the pod 32 may vary from application to application. In the illustrated embodiment, the information system 80 is configured to obtain information that identifies the type of beverage or beverages that can be produced from the pod 32. The controller 30 may use this information to obtain the appropriate brewing parameters from a look-up table or other data collection contained in a memory unit associated with the controller 30. Alternatively, when the beverage dispenser 10 is joined to a network of devices, the brewing parameters may be obtained from another device on the network. In an alternative embodiment, the information system 80 is capable of obtaining brewing instructions from the pod 32. For example, the pod 32 may include information that is encoded with the brewing parameters. If desired, the information system 80 is capable of obtaining other types of information, such as the expiration date of the ingredients contained in the pod 32. The controller 30 can use the expiration date to disable the system when an effort is made to use expired ingredients.

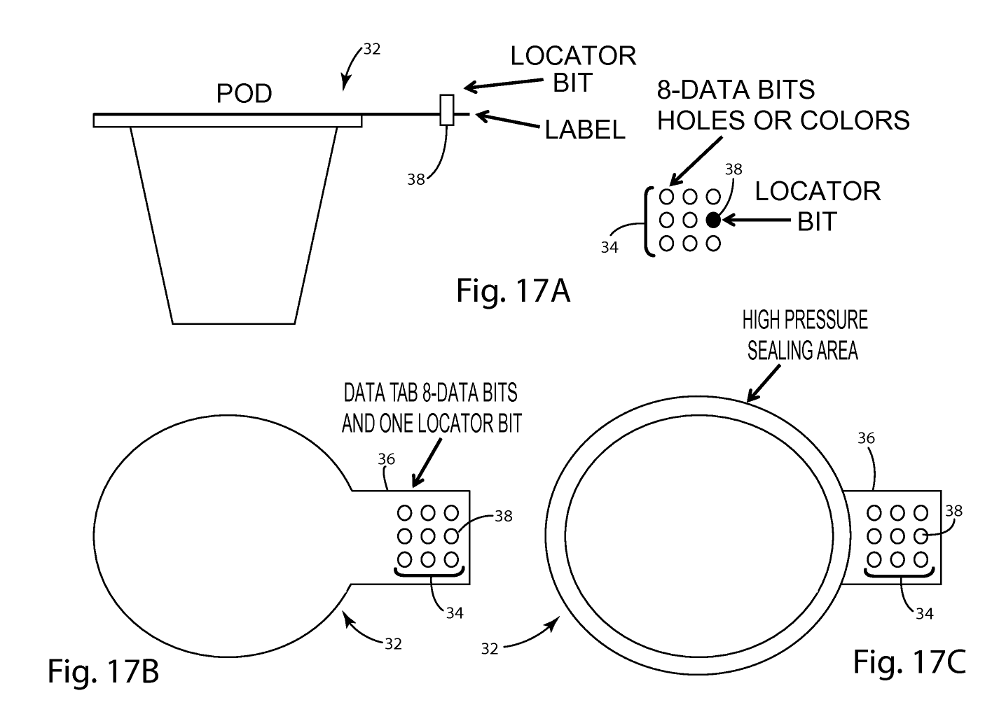

In the embodiment of FIG. 17, the identification system 80 is configured to read data bits 34 provided on a data tab 36 of the pod 32. In this embodiment, the data bits 34 are represented by the presence or absence of holes in predefined locations on the data tab 36. The data bits may additionally or alternatively be represented by other variations in shape/contour or by printed content on the data tab. For example, different color printing located at predefined locations on the data tab can be used to encode information. In the embodiment of FIG. 17, the data bits 34 are arranged in a regular array or grid, but the arrangement may vary from application to application.

The pod 32 of FIG. 17 includes a data tab 36 having a locator pin 38 that is fitted into a locating hole (not shown) in the brewing chamber 20. In this embodiment, the data tab 36 is disposed outside the high pressure sealing area (see FIG. 17) so that the data tab 36 and data reader are not subjected to the environment within the brewing chamber 20. The pod 32 may include additional or alternative locating structure. For example, the brewing chamber 20 may include a seat (not shown) that corresponds with the shape of the pod 32, including the data tab 36, and requires the pod 32 to be installed in the proper position and orientation. As another example, one of the holes in the data tab 36 may be configured to fit over a locating pin (not shown) in the brewing chamber 20. The size or shape of the locating hole may differ from the size or shape of the data bit holes to ensure that a data bit hole is not fitted into the locating pin.

In the illustrated embodiment, the information system 80 includes an optical data reader 82 configured to read data represented by the holes in the data tab 36. In this embodiment, the information system 80 may include a light source 84 located where it will be on one side of the data tab 36 and a plurality of photosensors 86 located where they will be on the opposite side of the data tab 36. Each photosensor 86 may be uniquely positioned beneath a specific data bit 34 so that the presence or absence of the hole can be determined based on whether or not the photosensor 86 senses light from the light source 84. The light source 84 may essentially any light source, but in the illustrated embodiment is an LED. The optical data reader 82 may also include a light pipe 88 positioned between the light source 84 and the data tab 36 to distribute light distribution over all of the data bits 34. The photosensors 86 may be essentially any component capable of providing an output that varies based on the presence or absence of light, such as photodiodes or LEDs. In use, the controller 30 may illuminate the light source 84 and receive input from the various photosensors 86 while the light source 84 is illuminated. The controller 30 may determine the identification number for the pod 32 by analyzing the output of the various photosensors 86.

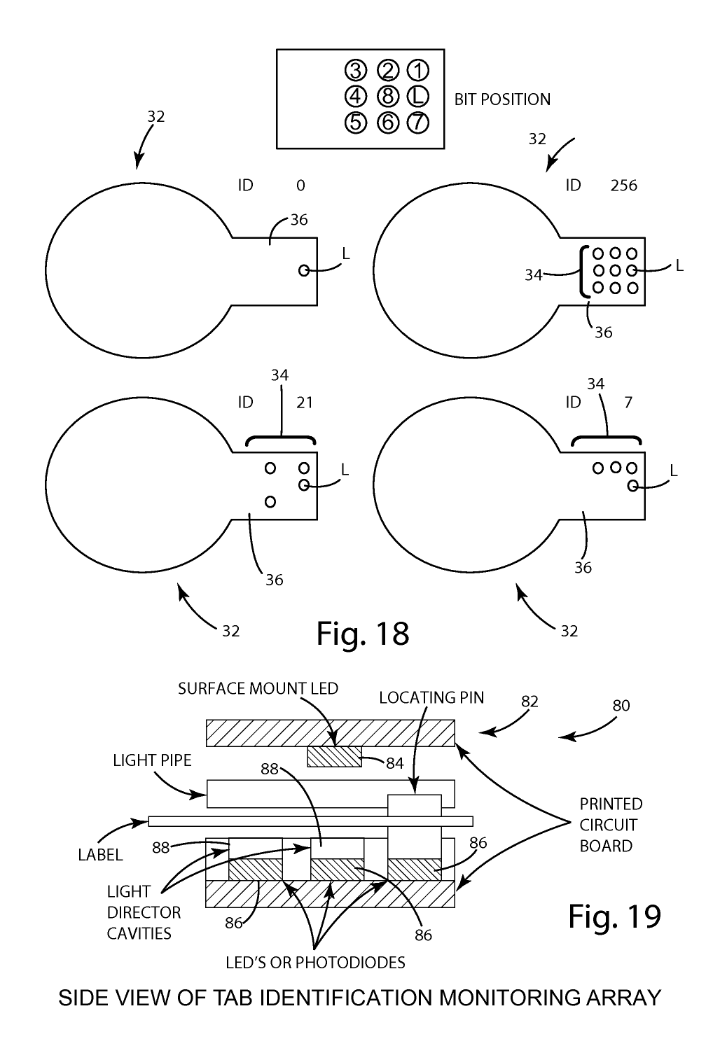

Referring again to FIG. 18, the data bits 34 of this embodiment are configured to provide the information system 80 with a pod-type identification number that represents the type of beverage (or beverages) that can be prepared from the ingredients within the pod 32. For example, the data bits 34 may represent a binary 8-bit number, and that number may represent the pod type. The use of 8 bits provides a range of numbers from 0 to 256. FIG. 18 shows how “0”, “21”, “256” and “7” may be represented using the 8-bit encoding scheme. The number of bits may vary depending on the range of number desired. For example, two additional bits may be added when it is desirable to have a range of number from 0 to 1024. The bit positions of the illustrated embodiment are shown in FIG. 18, but the bit positions may vary from application to application.

In this embodiment, the controller 30 is configured to obtain the preparation parameters for the beverage based on the identification number received from the pod 32. For example, the controller 30 may include a look-up table (stored in onboard or external memory) that contains the preparation parameters for the various types of beverages. The controller 30 of this embodiment uses the identification number obtained from each pod 32 as a key to the look-up table to allow the controller 30 to obtain the preparation parameters for that pod 32. The table of FIG. 1 shows the type of data that might be stored in the look-up table. The look-up table or other form of data collection can be preprogrammed into the beverage dispenser 10 or it can be provided or update through the use of a mobile device. As noted above, the data bits may alternatively present an encoded set of beverage preparation parameters. For example, the values of the various data bits may be selected to specify the beverage preparation parameters.

In the embodiment illustrated in FIG. 21, the pods 32 include additional data bits 90a-c (or flags) that are capable of being manipulated by the user to allow the user to provide customized information to the beverage dispenser 10. For example, the pods 32 may include one or more user-adjustable data bits or flags that allow the user to customize the beverage or the associated preparation process. The user-adjustable bits 90a-c may be varied by the user to define essentially any characteristic of the beverage, such as strength of brew, brewing temperature and/or additive ingredients. As a few examples, the pod may include a user-adjustable data bit that defines whether the user wants the beverage hot or cold, whether the user mays the beverage strong or mild, whether the user wants caffeine (or other additives) or whether the user would like an expedited or standard preparation process. In the illustrated embodiment, the user-adjustable bits are perforated portions of the data tab 36 that can be punched out by the user to create a hole that can be sensed by the data reader 82. The number and position of user-variable data bits may vary from application to application, as desired.

Alternative types of product identification may be used. For example, in applications where ingredients are separately loaded into the beverage dispenser 180, the ingredient containers 182 may include an RFID tag 184 or other similar device that identifies the ingredient to the beverage dispenser 180 (See FIG. 22). As shown, the beverage dispenser 180 may include an RFID reader 188 capable of identifying the ingredient by the RFID tag 184 incorporated into the container 182, and the beverage dispenser 180 may include a scale 186 for weighing the amount of ingredient added to the dispenser. Although shown with an RFID system, the beverage dispenser 180 and containers 182 may include alternative technology for wirelessly identifying the ingredient to the dispenser 180. In another alternative, the user may input the type and/or amount of ingredient into the beverage dispenser 180.

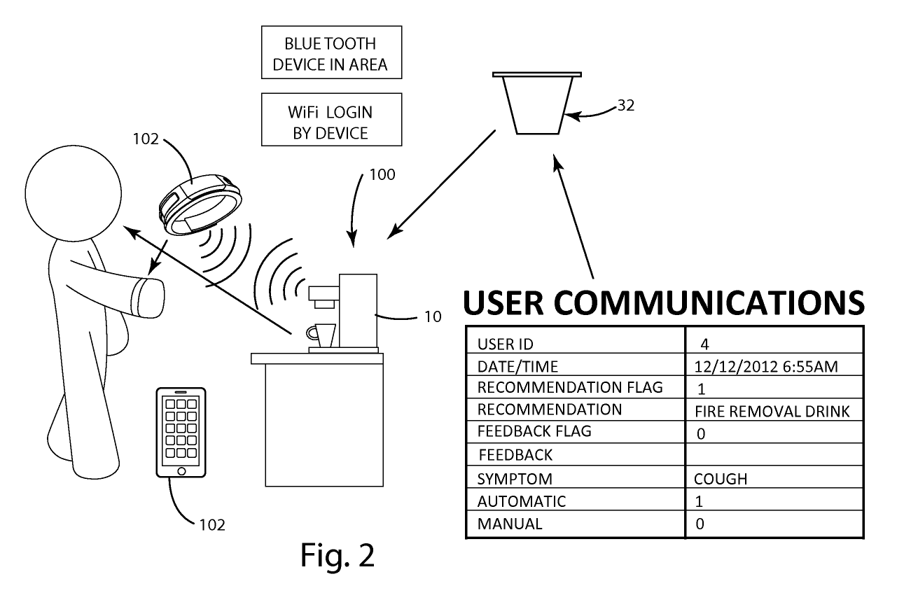

In the embodiment of FIG. 2, the beverage dispenser 10 includes a user assistance system 100. The user assistance system 100 may be capable of providing a user with beverage recommendations and of collecting information relating to a user's consumption of beverages. For example, FIG. 6 shows a table of the information collected by the user assistance system 100 relating to a history of beverage production. The table includes a number of flags and tags used by the system to track usage and user feedback. In this embodiment, each entry in the table corresponds to a brewing event. As shown, the data in the table includes a User ID field that identifies the user associated with that entry in the table (e.g. that particular brewing event), a Date/Time field that indicates when the beverage was brewed, a Recommendation Flag field that indicates whether the beverage was produced in accordance with a recommendation, a Recommendation field that identifies the beverage that was brewed, a Feedback Flag field that indicates whether the user provided feedback on the beverage, a Feedback field that includes the user feedback (once provided), a Symptom field that identifies any symptoms that user may be presenting at the time the beverage was brewed, an Automatic field that indicates whether the recommendation was generated by the beverage dispenser (or the user assistance system) and a Manual field that indicates whether the recommendation was provided by the user rather than by the beverage dispenser (or the user assistance system). The Manual field may be used to indicate that the recommendation was derived from the user manually answering questions, while the Automatic field may be used to indicate when a recommendation was automatically triggered by environmental or social data collected by the beverage dispenser or by the larger network of health and well-being products. The data used for automatic recommendations may include information obtained without user input or it may include information provided by the user. For example, the system may ask the user one or more questions that may assist the system in providing an automatic recommendations. The information maintained by the system (e.g. the table of information shown in FIG. 6) may allow the system to assess the effectiveness of various beverage formulations in treating different symptoms or other characteristics of the beverage formulations, such as taste. As a result, the information may be used to assess the effect of changes to a particular formulation and/or to provide improved recommendations in the future. For example, this information may allow a supplier of the formulations to understand the impact of changes to a formulation, such as the impact of changes in the source of a specific ingredient or changes in the relative proportion of different ingredients. It may also allow the supplier to assess the impact of changes to brewing parameters. For example, if user feedback indicates that a beverage is weak in flavor, future pods may be provided with increased brewing time. This particular collection of information is exemplary and the type of information collected may vary from application to application. The information collected by the user assistance system 100 may be provided to other devices that might be able to use the information in assisting the user in other ways. The user assistance system 100 may be part of a larger system that collects a variety of useful types of information from and about the user, and uses the collected information to assist the user in maintaining a high level of health and well-being, such as by providing the user with recommendations for maintaining or improving health and well-being. For example, the user assistance system 100 may be part of a network of devices (not shown) that collect information about a user's exercise and other physical activities, food and beverage consumption, sleep and other factors that may directly or indirectly affect or reflect the user's health, well-being or state of mind. Systems of this nature are described in U.S. application Ser. No. 13/455,634, entitled PILL DISPENSER, filed Apr. 25, 2012, by Baarman et al; International Publication No. WO 2013/086363, entitled BEHAVIOR TRACKING AND MODIFICATION SYSTEM, filed Dec. 7, 2012, by Baarman et al; and U.S. Provisional Application No. 61/567,692, entitled BEHAVIOR TRACKING AND MODIFICATION SYSTEM, filed Dec. 7, 2011, by Baarman et al, all of which are incorporated herein by reference in their entirety. These systems may also collection information about user preferences, which in the context of the beverage dispenser 10 may include preferences that relate to the selection and preparation parameters of beverages.

In this embodiment, the user assistance system 100 may be capable of analyzing the collected information and providing appropriate beverage recommendations, including beverage type and beverage additives. For example, the user assistance system may assess diet, such as food and beverage consumption, including alcohol consumption, and recommend a beverage type and/or functional additives to be included in a beverage. The user assistance system may also consider user-supplied information about how the user is feeling (e.g. stress level, general wellness, perceived energy level) or analyze sleep data collected about the user in making recommendations regarding beverage additives. The user assistance system may also review historical information when making a recommendation, such as a user's prior response to a given beverage formulation. In use, the user assistance system is capable of suggesting beverage types and/or beverage additives based on essentially any potentially relevant data this is either collected automatically by various monitoring systems or that is input into the system by the user.

In one embodiment, the user assistance system 100 is capable of communicating with a personal device 102 carried or worn by the user (See FIGS. 1 and 2). For example, the personal device 102 may be a wristband, a mobile phone or other electronic device. In one embodiment, the personal device 102 and user assistance system 100 are capable of communicating electronically, for example, via Bluetooth, WiFi or other wired or wireless communication systems. When the user comes within sufficient proximity to the beverage dispenser 10, a wireless communication link may be established between the personal device 102 and the beverage dispenser 10. The link may be established automatically or by user initiation. The personal device may carry the user's identification, as well as the user's preferences. The personal device or beverage dispenser (or some other component in a larger network of devices) may maintain a data record associated with each beverage recommendation and/or each beverage brewing event (for instances when a beverage that is not recommended is brewed). For example, FIG. 2 shows a table containing information that might be tracked and maintained. The data contained in this table may vary from application to application. However, in the illustrated embodiment, the table includes a User ID field that contains the user id of the user associated with the record. The Date/Time field may include the date and time of the brewing event. The Recommendation Flag field indicates whether the beverage was brewed in accordance with a recommendation. The Recommendation field contains the name of the recommended beverage formula. The Feedback Flag indicates whether the user provide feedback on the beverage. The Feedback field includes the user feedback, such as efficacy or taste. The Symptom field contains the symptoms the user may have been exhibiting when the beverage was brewed. The Automatic field indicates whether the recommendation was generated automatically. The Manual field indicates whether the recommendation was derived from the user manually answering questions. The data record shown in FIG. 2 is a data record that may be associated with a single brewing event or a single beverage recommendation. The data may be provided by the beverage dispenser 10 with information obtained from the personal device 102, the beverage dispenser 10 or other network components. The completed data record might be communicated back to the personal device 102 and/or to the larger network of devices. From this information, the beverage dispenser 10 is able to provide beverages customized to the user's preferences. Further, the beverage dispenser 10 may use the user's identification to transmit user information to the larger network of devices.

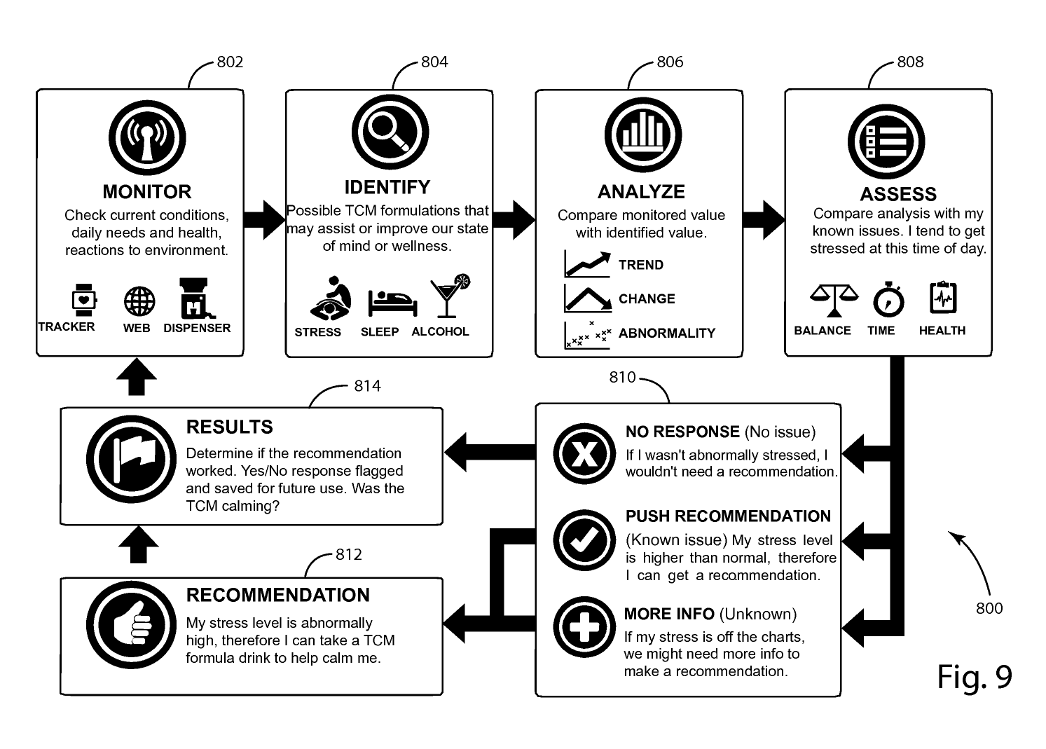

An example of the recommendation and feedback process 800 of one embodiment is shown in FIG. 9. In this embodiment, the system 100 is periodically monitoring 802 current user conditions, which may include daily needs, such as health and well-being needs, as well as environmental conditions that might affect the user. This information may be provided to the system 100 by the personal device 102, through external devices (e.g. devices included in a larger network of device that may communicate via the web) or may be collected directly by the beverage dispenser 10, such as through the use of an integrated keyboard, touchscreen, buttons, switches or other input devices. The user assistance system 100 of this embodiment will next identify 804 potential TCM formulations that may assist or improve the user's health, well-being or state of mind. This identification may be based on the information obtained in the monitoring stage. In this embodiment, the system 100 next analyzes 806 the monitored information and the identified formulations. For example, the system 100 may, among other things, compare the monitored information and the identified formulations to determine if there are any trends, changes or abnormalities. This may involve a comparison of the monitored information with historical data. For example, the system 100 may monitor the effectiveness of a particular formulation over time. This may allow the supplier of the formulations to assess changes to the formulation over time, such as changes in the source of a particular ingredient or changes in the way the ingredient is processed. In one embodiment, the data collection for a large number of users can be combined and analyzed together, for example, in a way similar to a clinical registry. By combining data from a large universe of users, the system is able to increase the statistical relevance of the data, which allows decisions to be made with a higher level of statistical confidence. As another example, the system 100 may be used to test a target hypothesis (e.g. the hypothesis that a specific beverage formulation will address an identified issue) generated based on a potential solution to be used in the market. The hypothesis may, for example, be directed to limiting the effects of the common cold. The target hypothesis can then be tested through consumption of the beverage formulation and statistics watching the recommendations (FIG. 2 User Communications table). The information provided through the User Communications table allows the system to identify compliance (e.g. that the user has consumed the suggested recommendation), to determine whether the user provided feedback and to collect positive and negative user feedback. When this data is gathered in mass and compared statistically it may be possible to see the impact of a given formulation for efficacy on a statistically relevant basis. This allows verification and refinement of formulations against the target hypothesis. The system 100 may then compare 808 the analysis results with information specific to the user, such as known issues relating to health, well-being or state of mind. For example, the system 100 may consider whether the user has a tendency to become stressed later in the day or has other issues that might warrant specific action. The system 100 of this embodiment will next seek user input 810. More particularly, the system 100 may ask the user questions that solicit a response indicative of the user's current health, well-being and/or state of mind. The user feedback may be used by the system 100 to determine whether or not to make a recommendation 812 to the user and, if so, it may be used to tailor the recommendation. For example, if the system 100 knows that the user is typically subject to a high level of stress late in the day, the system 100 may initially identify a TCM formulation intended to reduce stress. If the user feedback indicates that the user is not actually stressed, the system 100 may elect not to recommend a stress reduction formula. The system 100 may also track 814 the effectiveness of the recommendation. For example, the system 100 may seek user input on the effect of the formula. In addition to user input, the system 100 may monitor devices capable of collecting information regarding the issue to be addressed. For example, the system 100 may monitor the output of a heart rate monitor to determine whether a formula was successful in reducing the user's heart rate.

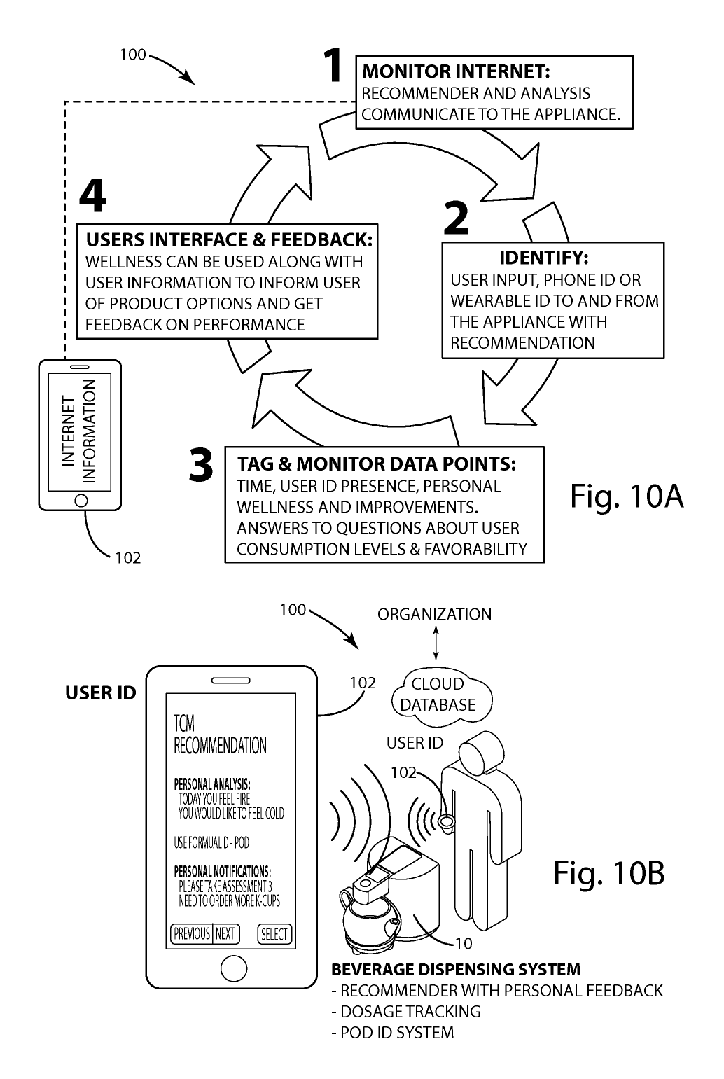

Referring now to FIGS. 10A-B, the user assistance system 100 of the illustrated embodiment is capable of interacting with a user via a personal device 102 using a simple application running on the personal device 102. In this embodiment, the personal device 102 is a smart phone that has wireless communications capabilities that allow the personal device 102 to communicate with beverage dispenser 10 and any other devices that might be part of a larger network of device configure to collect information and provide user assistance. In this embodiment, the personal device 102 may communicate directly with the beverage dispenser 10 and with other network device that collect user information. The personal device 102 may provide information from other network device to the beverage dispenser 10 (or vice versa). In this embodiment, the personal device 102 contains the user identification and may be used as a mechanism for providing input to the beverage dispenser 10 or other network devices. The personal device 102 may collect information that is relevant to user health, well-being or state of mind. For example, the personal device 102 may maintain data relating to personal wellness characteristics that might be affected through beverage recommendations, such as data relating to weight, gate, consumption/intake and environmental conditions. The personal device 102 may provide other functions, as well, such as tracking time and identifying the user's presence to the beverage dispenser (e.g. by communicating the User ID to the beverage dispenser). The personal device 102 may be a networked device with many data points, and may be able to provide valuable social and environmental conditions that can be useful in generating recommendations. The beverage dispenser 10 may rely on the personal device 102 to function as a user interface for the beverage dispenser 10. More specifically, the user may interact with an application on the personal device 102 to interact with the beverage dispenser 10. For example, the personal device 102 may present the user with beverage recommendations, with potential beverage options (such as, temperature, strength and additive ingredients) and the user may provide feedback to the system 100 regarding the results of the effectiveness of the beverage. The user assistance system 100 may be capable of communicating directly with the larger network of devices, or it may communicate with the larger network of devices via the personal devices of users of the beverage dispenser 10.

In some embodiments, the system 100 may include a wearable device, such as a wristband, clip-on device or other similar product (See, e.g., FIGS. 2 and 10A-B). When included, the wearable device may be capable of communicating directly with the beverage dispenser and/or it may be configured to communicate with the beverage dispenser via a handheld electronic device, such as a smart phone. In such applications, the smart phone or other electronic device may run an application that provides a user interface between the wearable device and the user, thereby allowing sophisticated interaction between the user and the wearable device even in the absence of a full user interface on the wearable device. The wearable device may also be capable of communicating with other devices in a larger network, either directly or indirectly using another electronic device, such as a smart phone as discussed above.

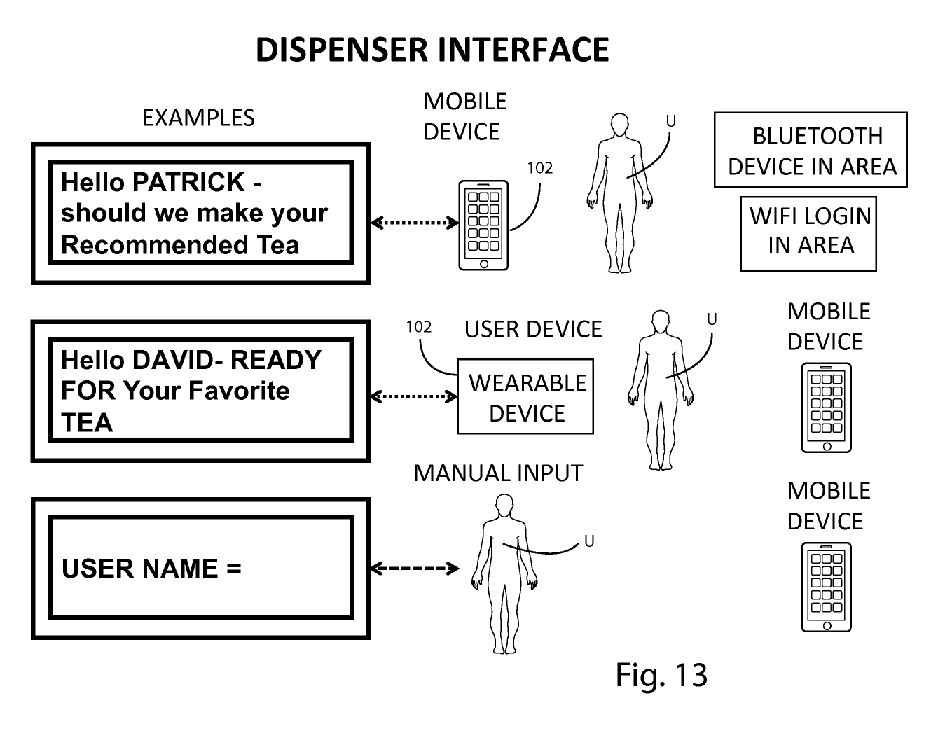

FIG. 13 shows an example of a beverage dispenser interface. The interface may be presented on a display integrated into the beverage dispenser and/or it may be shown on the display of a personal device 102. The user may provide input to the beverage dispenser 10 using the personal device 102, or through the use of an input device integrated into the beverage dispenser 10, such as a keyboard, touch screen or arrangement of input buttons.

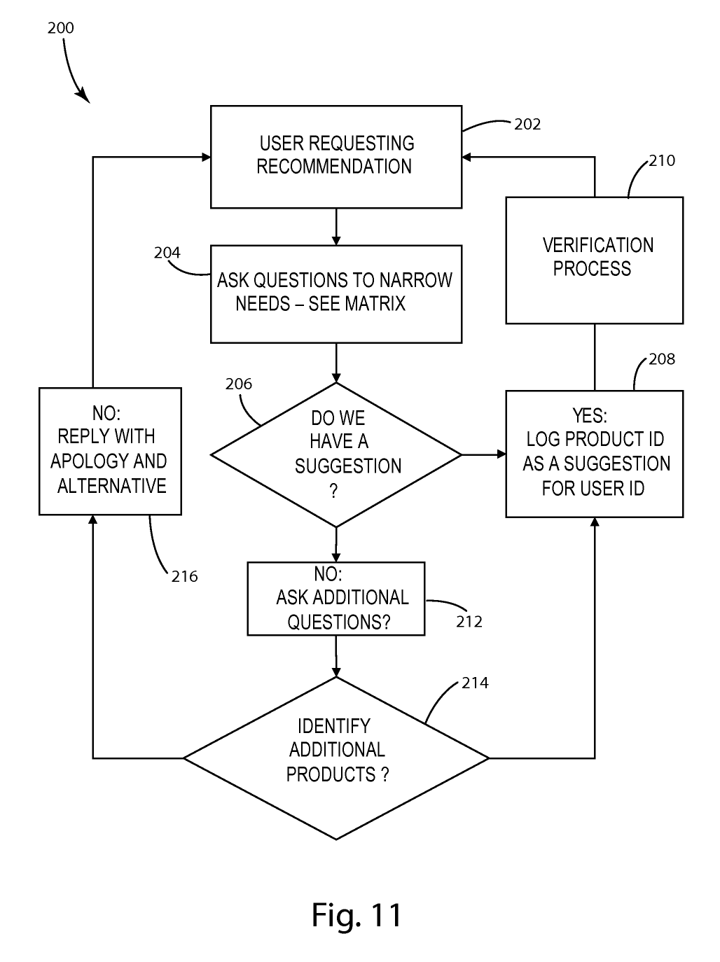

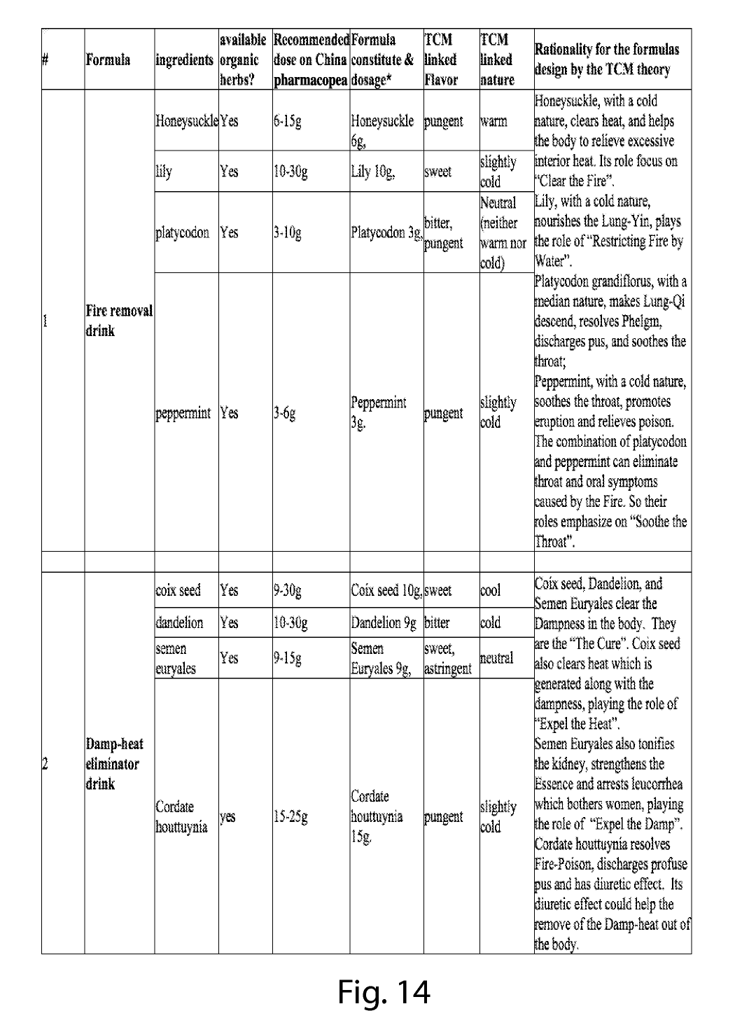

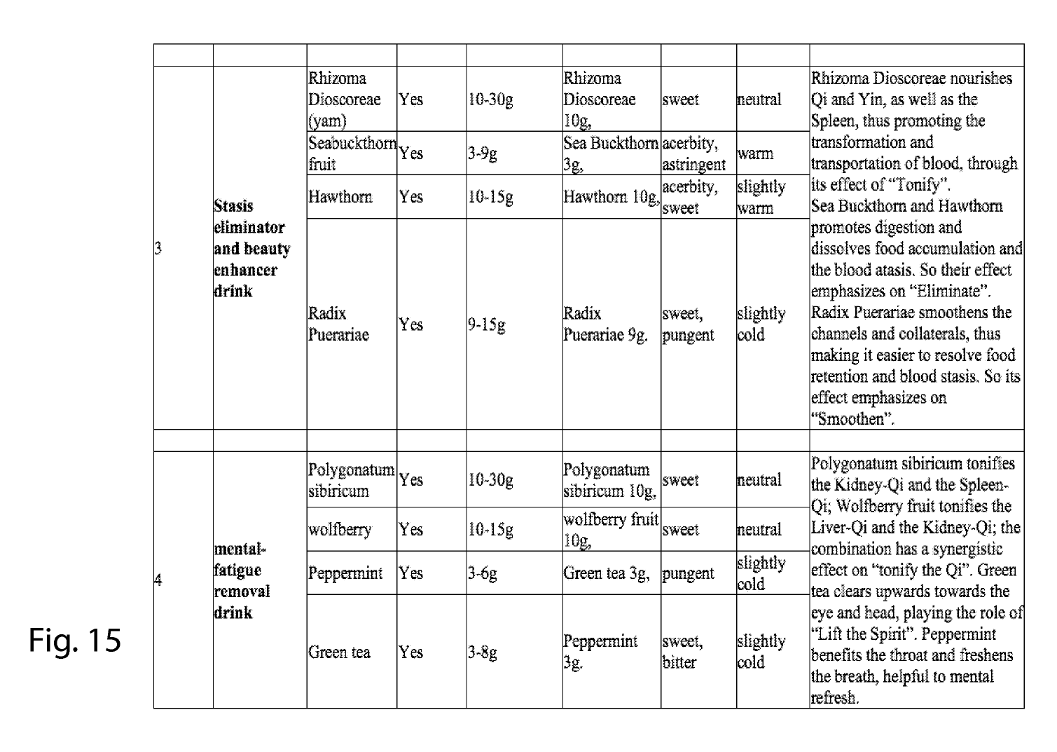

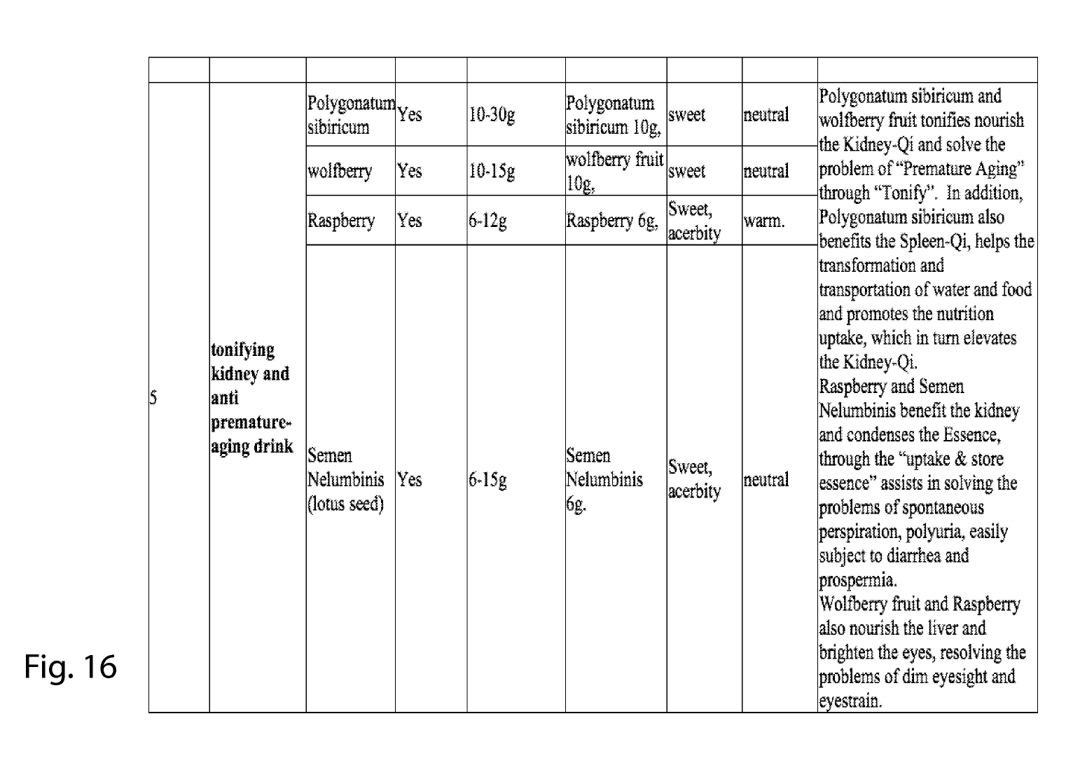

FIG. 11 shows the general steps of one recommendation process 200 that may be implemented by the user assistance system 100. The process begins with the user requesting assistance 202, the user assistance system 100 then asks one or more questions that allow the system to consider potential suggestions 204. For example, the system 100 may ask questions that allow the system to determine if the user is manifesting symptoms that might be addressed by any of the TCM formulations available for use with the beverage dispenser. The questions may include essentially any inquiry that might help the system to identify the user's symptoms or to identify a result that the user would like to achieve. Although the present invention is described in connection with a system capable of brewing the five TCM formulations shown in FIGS. 14-16, the system may be capable of brewing additional and/or alternative formulations, as desired. In each application, the questions posed by the system may be selected to be consistent with the range of formulations capable of production using the beverage dispenser. The system may include questions relating to additive ingredients and not merely the base formulations. For example, the system may ask questions to determine whether additional vitamins or food supplements might be helpful to the user. The system may also ask questions that relate to the user's preferences. For example, the system may ask questions relating the user's flavor or temperature preferences. They may also allow a user to manually input a formulation and/or additive ingredients. If the answers are sufficient to allow the system 100 to make a recommendation 206, the system 100 logs the product ID for the formula as a suggestion for the user 208. Once the suggested formula has been logged, the system 100 carries out a verification process 210 to confirm that the beverage has been consumed. The verification process 210 may include the system asking the user various questions, such as to confirm that the beverage was consumed and to identify whether the user liked the beverage (e.g. taste, flavor, temperature). The system may also request user feedback on the efficacy of the beverage. In applications where efficacy is immediately known, the verification process 210 may include immediately asking the user for feedback. In applications where efficacy is not immediately known, the system may log a reminder to request feedback at a future date and time. If desired, the system may ask for immediate feedback and for feedback at some future time. If the answers to the questions are not sufficient to make a recommendation, the system 100 may move on and ask additional questions that might be sufficient to make a recommendation 212 relating to a beverage or to other types of products. If the new answers are sufficient to make a recommendation 214, the system 100 logs the product ID for the formula as a suggestion for the user 208 and the process proceeds to the verification step 210, as discussed above. If the system still cannot provide a beverage recommendation, the system 100 replies to the user with a message that indicates that a beverage recommendation is not available 216. Even if a beverage recommendation is not available, the system may make recommendations for other products or services. For example, the system 100 may ask questions that help determine whether the user might benefit from vitamins, minerals or other food supplements that can be provided to the user separate and apart from the beverage dispenser. If so, the system may present the recommendation to the user and allow the user to order the recommended product electronically to be shipped to the user. Although described in the context of providing food supplements, the system may be capable of asking questions relating to essentially any products that might relate to the health and well-being of the user. In the described embodiment, the system considers non-beverage recommendations when a beverage recommendation is not available. As an alternative, the system may consider non-beverage recommendations even if a beverage recommendation is available.

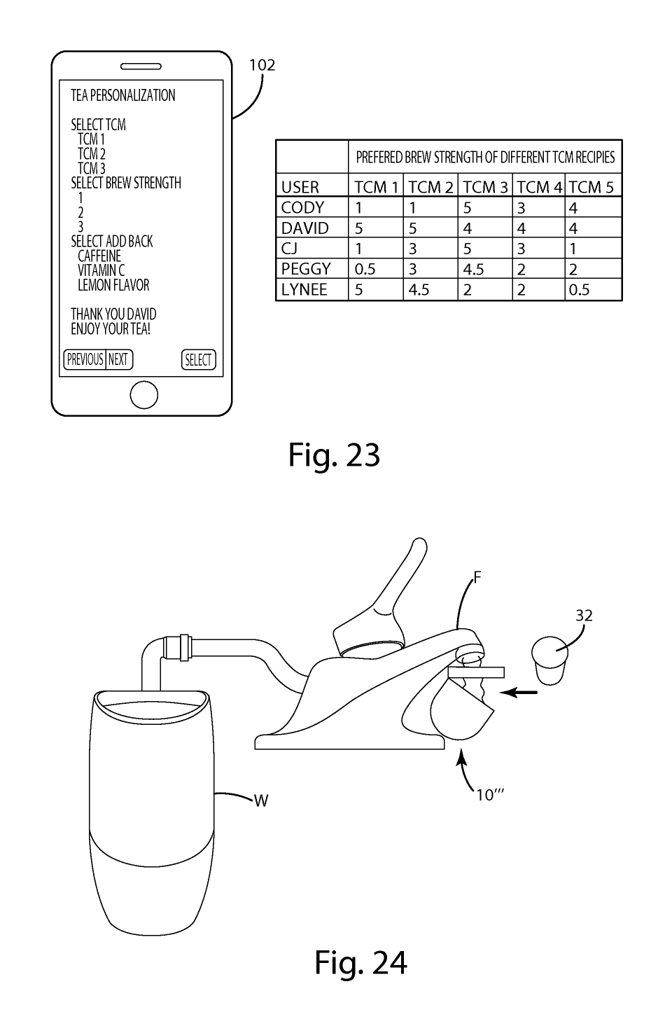

As noted above, the beverage dispenser 10 may be capable of customizing the prepared beverage based on customer preferences. For example, this functionality may allow the dispenser 10 to customize the brew strength of various TCM formulas based on predefined user preferences. FIG. 23 shows a table of brew strength preferences for a plurality of users and a plurality of TCM formulas. In this embodiment, user preferences may be entered into the system using a personal device 102, as shown in FIG. 23. Alternatively, the preferences may be entered directly into the beverage dispenser 10 or into another device that is capable of communicating with the beverage dispenser through a network.

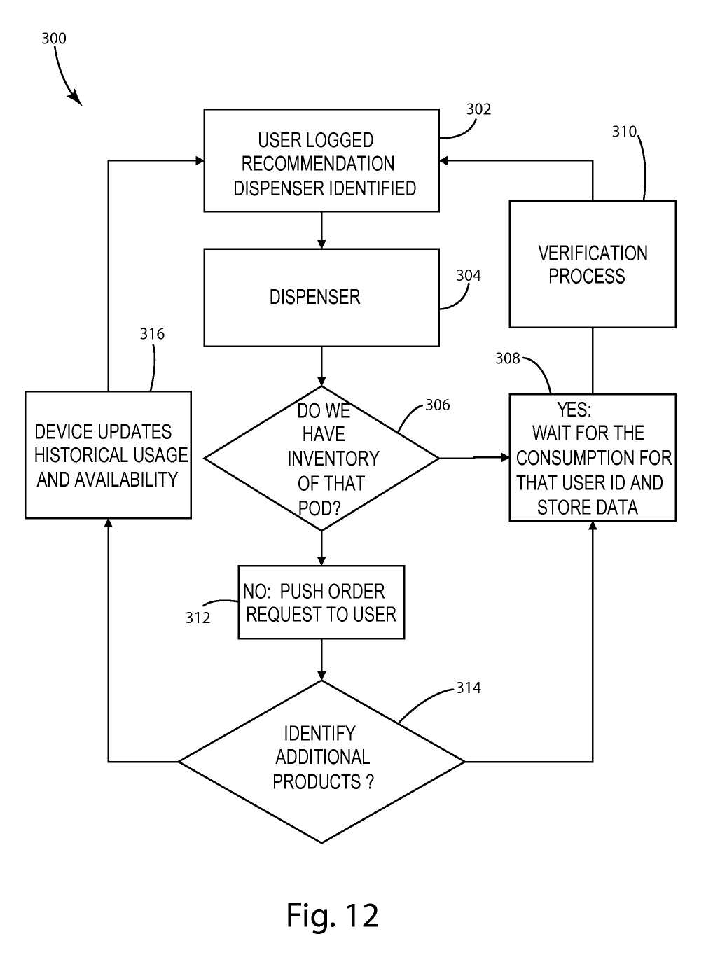

FIG. 12 shows the general steps of a compliance tracking, inventory tracking and reordering process 300. In this embodiment, the method is configured to first identify 302 the dispenser that is capable of satisfying the recommendation. In the embodiment, the method is intended for use with a larger network of devices and is not limited for use with a beverage dispenser. In this context, the system may provide recommendations that are filled by the beverage dispenser or may provide recommendations that are filled by other devices. For example, the system may recommend vitamins, minerals or other food supplements that are dispensed by a pill dispenser (not shown). A pill dispenser that may be suitable for use in this system is described in U.S. application Ser. No. 13/455,634, entitled PILL DISPENSER, filed Apr. 25, 2012, by Baarman et al.

Once the correct dispenser (or other device) is identified, the process transitions to that device 304 for further processing. The dispenser is queried to determine if there is sufficient inventory to fill the recommendation 306. With a beverage dispenser, this may include determining whether a dispenser with bulk ingredient storage has sufficient ingredient in its bulk storage to produce the recommended beverage or whether the appropriate TCM formulation pod has been inserted into the beverage dispenser when it does not have bulk storage. In the context of a pill dispenser, this step may include determining whether the inventory of the pill dispenser is sufficient to dispense the recommended pills.

If the dispenser has sufficient inventory to fulfill the recommendation, the system may dispense the recommendation and, upon consumption, store the user ID and data relating to the recommendation 308. For example, with a beverage dispenser, the system may wait for a consumption signal from the user and then may store the data shown in the table of FIG. 2. The beverage dispenser may prompt for confirmation or may wait for the user to enter a confirmation signal unsolicited.

The system may verify that the user has provided feedback on the recommendation 310. For example, the system may solicit immediate feedback and/or set up a schedule to seek feedback from the user in the future. With a beverage recommendation, the system may immediately request feedback on taste, temperature and any other factors that might be immediately discernible by the user. The system may also (or alternatively) set a time and date in the future to request feedback on the efficacy of the recommendation. The date and time may be selected to allow sufficient time to pass for the user to assess the efficacy of the recommendation.

If the dispenser does not have sufficient inventory, the system may ask the user whether or not to order/reorder the product 312. The system may be configured to request authorization to reorder a product even before the inventory is exhausted. For example, the system may request authorization to reorder by assessing the typical consumption rate of an item and the typical time required to fulfill an order. To illustrate, if a consumer typically consumes two beverages pods of certain type each day and reorder fulfillment typically takes three days, the system may be configured to request authorization to reorder that beverage formulation when the inventory is down to eight pods. Although the system may be configured to request uder authorization to reorder when inventory is exhausted or low, the system may have the ability to reorder without requiring user authorization each time, when desired.

As with the method described above in connection with FIG. 11, the system may identify additional products or services that might be helpful to the user 314. This may include additional products from that dispenser or products and service offered separate and apart from that dispenser. If the inquiries associated with step 314 lead to a recommendation from that dispenser, the recommended item can be dispensed and control may pass to block 308 to wait for consumption. If the inquires lead to a recommendation not available from that dispenser, the system may request authorization to order the recommendation for the user. This may allow the system to electronically fulfill the order. If the recommendation may be fulfilled by another dispenser in the larger network of devices, the dispenser may communicate the recommendation to the user and/or to the device capable of dispensing the recommendation. For example, the recommendation may be sent by the dispenser to the user's personal device so that the user is aware of the recommendation and it may also be sent directly to the network device capable of fulfilling the recommendation. As an alternative to sending the recommendation directly to the device capable of fulfilling the recommendation, the recommendation may be stored on the personal device and communicated to the device capable of fulfilling the recommendation when the user approached or activates that device.

In this embodiment, the system updates historical usage and availability data retained within the system 316. In the illustrated embodiment, this step occurs only when inventory for the recommended product is not available. Alternatively, that information could be collected and retained whether or not the dispenser includes sufficient inventory.

As noted above, the design and configuration of the beverage dispenser may vary from application to application. For example, the arrangement of passages and valves may be varied depending on the intended operation of the beverage dispenser. To illustrate, an alternative beverage dispenser 410 is shown in FIG. 7B. In this embodiment, the beverage dispenser 410 includes one less valve and one less flow passage. This configuration has the benefit of reducing the complexity and cost of the beverage dispenser 410, but it eliminates the ability of the system to discharge water through the drain 424 without moving it through the brewing chamber 420 Like beverage dispenser 10, beverage dispenser 410 generally includes a housing 412 containing a water tank 414, a pump 416, a heater 418, a brewing chamber 420, a beverage outlet 422 and a drain 424. The dispenser 410 also includes a flow network including a plurality of passages 426 and a plurality of valves 428a-d for controlling the flow of liquid through the system. The beverage dispenser 410 includes a controller 430 configured to control operation of the system, including operation of the pump 416, heater 418 and various valves 428a-d. Except as otherwise described, the beverage dispenser 410 of FIG. 7B may be essentially identical to the beverage dispenser of FIG. 7A.

### Operation of Beverage Dispenser

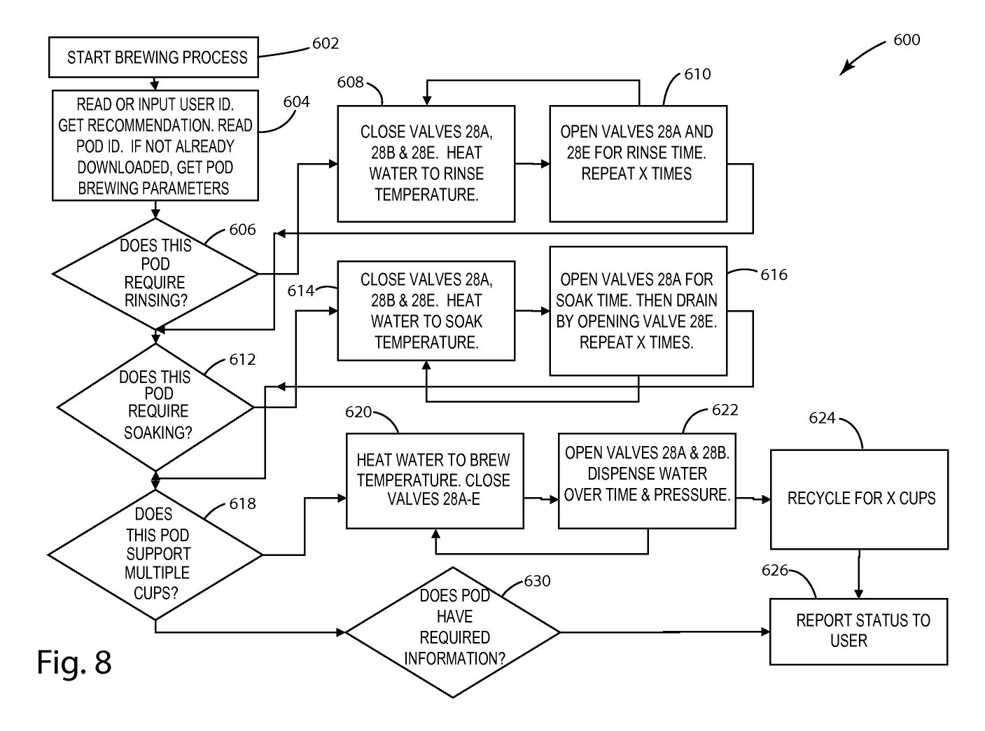

General operation of the beverage dispenser 10 of FIG. 7A will now be described in connection with the general brewing process shown in the flow chart of FIG. 8. This general brewing process includes rinse, soak and brew modes of operation. The number and type of available modes of operation may vary from application, as desired. For example, the illustrated brewing process may be expanded to include a steam soak mode of operation in which the ingredients are subjected to steam.

Referring now to FIG. 8, the brewing process 600 begins at start block 602. At block 604, the beverage dispenser 10 performs some initial activities that, among other things, identify the user and obtain any beverage recommendation. This can be achieved, for example, through communications between the beverage dispenser 10 and a personal device 102 carried by the user. The personal device 102 may automatically or upon user initiation transmit a user id to the beverage dispenser 10. If the personal device 102 also holds a beverage recommendation in memory, that recommendation can be transmitted to the beverage dispenser 10. Alternatively, the beverage dispenser 10 may obtain a beverage recommendation from a larger network of devices configured to assist in maintaining the health and well-being of the user. For example, the network may include a centralized server that collect information about the user and generates appropriate recommendations. As another example, the user may manually input the user id and may manually answer questions that might be used by the beverage dispenser 10 to generate a beverage recommendation. The user may manually enter information by entering it into a personal device 102, such as a smartphone, that transmits the information to the beverage dispenser 10. As another example, the user may manually enter information by entering it using an interface (keyboard, touch screen, etc.) built into the beverage dispenser 10. As another option, the beverage dispenser 10 may prepare whatever beverage is loaded into the brewing chamber. This option may be followed when there is no recommendation or the user elects not to brew the recommended beverage.

The beverage dispenser 10 may next read the pod information from the pod loaded into the brewing chamber using the information system. If the beverage dispenser 10 is attempting to prepare a specific recommendation, the beverage dispenser 10 can make sure the correct pod is loaded into the brewing chamber. If not, it can use the pod information to determine what it is preparing. The beverage dispenser 10 can obtain the appropriate brewing parameters, for example, by obtaining them from the pod or by pulling them from a database using the pod information as an index. If the brewing parameters are not include in the pod information and are not included in a database stored in the beverage dispenser, the beverage dispenser may download the brewing parameters from a network device, such as a server accessible over the Internet. The brewing parameters may include a list of brewing steps, as well as the parameters for each steps, such as time, temperature and pressure. As discussed elsewhere, the beverage formula and brewing parameters may be customized for the user, as desired.

With reference to block 630, it should be noted that if the pod does not have the required information (e.g. the ingredients have expired, the pod is not the correct pod for the desired beverage or it appears to be a counterfeit pod), the controller 30 may not engage the brewing process, but may instead report the issue to the user, for example, using a display on the beverage dispenser 10 or via the personal device 102.

The beverage dispenser 10 next determines at block 606 whether the installed pod requires rinsing. This determination may involve reference to the brewing parameters. If the brewing parameters call for the pod ingredients to be rinsed, control passes to block 608. At block 608, the controller 30 engages the heater 18 to heat the water from the tank to the rinse temperature. The rinse temperature may be specified in the brewing parameters. During this stage, the controller 30 closes valves 28a-e until the threshold rinse temperature is reached. After the threshold temperature is reached, control passes to block 610 and the controller 30 opens valve 28a, b and e, and engages the pump 18 for the rinse time. The rinse time may be specified in the brewing parameters. Blocks 608 and 610 may be repeated the desired number of times, which may be specified in the brewing parameters.

Next, control passes to block 612 where the controller 30 determines whether the pod requires soaking. This may be specified in the brewing parameters. If the brewing parameters call for the pod ingredients to be soaked, control passes to block 614. At block 614, the controller 30 engages the heater 18 to heat the water from the tank to the soak temperature. The soak temperature may be specified in the brewing parameters. During this stage, the controller 30 closes valves 28a-e until the threshold soak temperature is reached. After the threshold temperature is reached, control passes to block 616 and the controller 30 opens valve 28a and engages the pump 18 for the soak time. The soak time may be specified in the brewing parameters. When the soak time is complete, the controller 30 opens valve 28e to allow rinse water to drain. Blocks 614 and 616 may be repeated the desired number of times, which may be specified in the brewing parameters.

After any desired rinsing and soaking, control passes to block 618. At block 618, the controller 30 prepares to brew the beverage. At block 620, the controller 30 engages the heater 18 to heat the water from the tank to the brew temperature. The brew temperature may be specified in the brewing parameters. During this stage, the controller 30 closes valves 28a-e until the threshold brew temperature is reached. After the threshold temperature is reached, control passes to block 622, where the controller 30 opens valve 28a and 28b, and engages the pump 18 for the brewing time. This allows the beverage to be dispensed over time and pressure. The brewing time and pressure may be specified in the brewing parameters. Once brewing is complete, control transfers to block 624, which causes blocks 620 and 622 to be repeated if the pod is capable of supporting multiple brewing cycles. The ability of the pod to support multiple brewing cycles may be specified in the brewing parameters. Once brewing is complete, control may pass to block 626. At block 626, the beverage dispenser 10 may report status (e.g. “brewing complete”) to the user. Status may be reported to the user via the personal device 102 or via an output device incorporated into the beverage dispenser 10.

Brewing process 600 is merely exemplary of a general brewing process that may be implemented using beverage dispenser 10. This process, as described, incorporates various optional aspects, such as to use of a user id, the implementation of a recommendation system, the incorporation of a pod information system and the integration of a larger network of health and wellness devices. Further, the brewing process 600 is described in connection with a limited set of modes of operation. A beverage dispenser may implement other modes of operation, as desired.

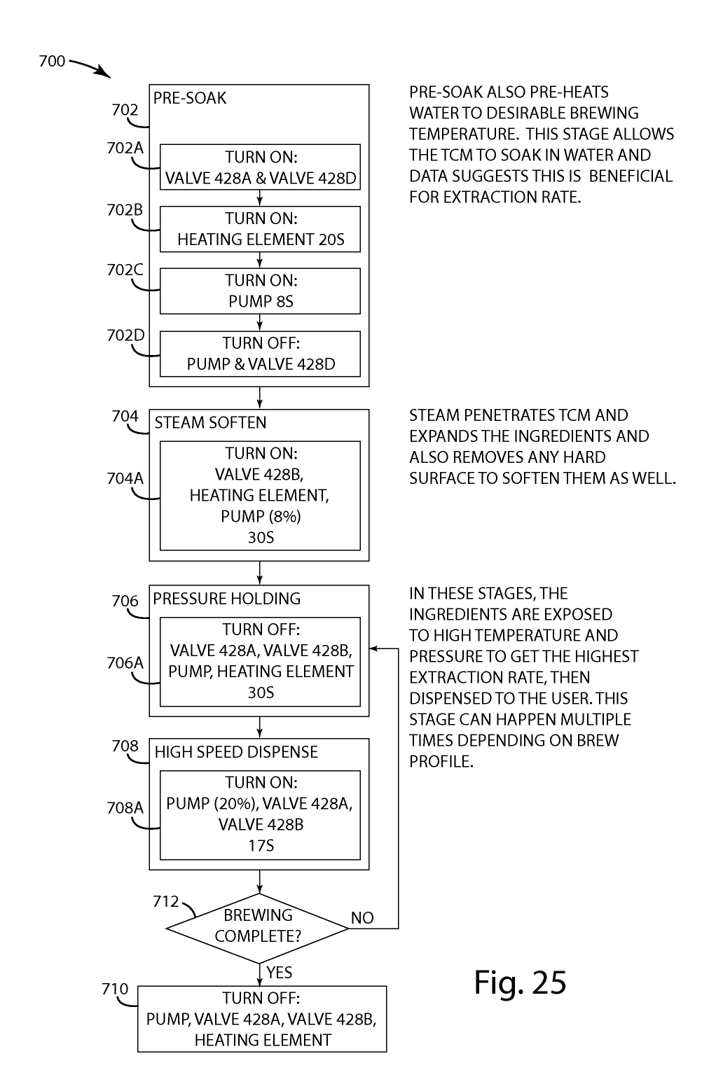

The above-described brewing process is merely exemplary. The brewing process may vary from application to application, from beverage to beverage and from beverage dispenser to beverage dispenser. As an example of this variation, operation of beverage dispenser 410 of FIG. 7B will now be described in accordance with the brewing process 700 set forth in FIG. 25. The brewing process 700 of FIG. 25 generally implements five sequential modes of operation: (1) pre-soaking 702, (2) steam softening 704, (3) pressure holding 706, (4) high speed dispense 708 and (5) shut-off 710. The beverage dispenser 410 of FIG. 7B generally includes a pump 416, a heater 418 and four valves 428a-d that can be actuated by the controller 430 to implement a wide variety of brewing steps or brewing procedures. As discussed above, beverage dispenser 410 has the ability to adjust a variety of brewing parameters and to prepare beverages in accordance with different recipes. For example, the beverage dispenser 410 may be capable of varying preparation time, temperature and pressure, and varying the ingredients included in a beverage. The ability of the dispenser 410 to adjust time, temperate and pressure allow it to implement various optional preparation stages. The stage employed in preparing any specific beverage may vary depending on the ingredients contained in the beverage formula.

In the illustrated embodiment, the beverage dispenser 410 is capable of pre-soaking the ingredients 702. Pre-soaking allows the ingredients to soak in water, which data suggests is beneficial for extraction rate. The pre-soak stage may also be beneficial in that it can pre-heat water to a desirable brewing temperature. Pre-soaking may be performed using water of essentially any temperature and pressure. If desired, the pre-soak may be performed using steam rather than liquid water. The length of the pre-soak may also be varied by the dispenser. To perform a pre-soak, water of the desired pressure and temperature is pumped into the brewing chamber 420 and held there for the desired period of time. The water used in performing the pre-soak may be discharged from the system through the drain 424 or it may be used in the beverage. With regard to the beverage dispenser embodiment shown in FIG. 7B, a pre-soak is performed by: (a) opening valve 428a and valve 428d to allow water to be pumped into the brewing chamber 420 (702a); (b) turning on heater 418 for a period of time (e.g. 20 seconds) (702b); (c) engaging pump 416 for a period of time (e.g. 8 seconds) (702c) and (d) turning off the pump 416 and closing valve 428d (702d). Valve 428a may also be closed if the new stage does not require it to be open.

In addition or as an alternative to pre-soaking, the dispenser 410 of the illustrated embodiment is able to steam soften 704 the ingredients. Steam softening may be beneficial in some applications because it may penetrate the ingredients and cause them to expand. It may also remove any hard surfaces, softening them to facilitate extraction. The time, temperature and pressure of the steam soften stage may vary from application to application. A steam soften is performed by pumping steam into the brewing chamber 420. The dispenser 410 may hold a volume of steam in the brewing chamber 420 or it may continuously introduce new steam into the brew chamber 420. The water condensate resulting from the steam soften may be discharged from the system through the drain 424 or it may be used in the beverage. With regard to the embodiment shown in FIG. 7B, a steam soften is performed by: (a) opening valve 428a (if not open already) and valve 428b to allow steam to be pumped through the brewing chamber 420 to the beverage outlet 422; (b) turning on heater 418; and (c) engaging pump 416 (collectively step 704a of FIG. 25). The pump 416 may be engaged at less than full power. For example, the pump 416 may be engaged at a duty cycle of about 8%. The heater 418 and pump 416 remain on for a period of time (e.g. 30 seconds). When the desired time has passed, the pump 416 and heater 418 can be turned off. Valves 428a and 428b may be closed depending on the next stage to be performed.

In this embodiment, brewing is performed by the general steps of pressure holding 706 and high speed dispense 708. To perform brewing, the beverage dispenser 410 may pump water at the desired pressure and temperature into the brewing chamber 420. Generally speaking, the brewing process will be performed at elevated temperatures and pressures to get optimal extraction rates. The water is retained in the brewing chamber 420 for the desired period of time and then discharge from the brewing chamber 420 through the beverage outlet 422. The brewing process may include a plurality of cycles of pumping water into the brewing chamber, holding it for a period of time and then discharging it from the brewing chamber. With reference to FIGS. 7B and 25, the brewing stage may include the steps of: (a) opening valve 428a and closing valve 428b, (b) turning on heater 418 and pump 416 to supply water to the brewing chamber 420 at the desired pressure and temperature, (c) closing valve 428a and allowing pressure to hold for a period of time (e.g. 30 seconds) (In FIG. 25, steps (a), (b) and (c) collectively shown as block 706a), and (d) opening valve 428b to allow the contents of the brewing chamber to be dispensed through the beverage outlet 422. Existing pressure in the brewing chamber and gravity may allow the contents to discharge. Alternatively, to discharge the contents of the brewing chamber 420, valves 428a and 428b may be opened and the pump 416 may be engaged (708a). In this embodiment, the pump 416 is engaged at about 20% duty cycle for about 17 seconds. As can be seen, the brewing chamber 420 is held under pressure for a period of time. Although the time and pressure may vary, in the illustrated embodiment, the brewing chamber is held at about 3-4 bar for a period of about 30 seconds. The process of filling, holding and discharging the brewing chamber 420 may be repeated until brewing is complete (712). Once brewing is complete, the pump 416 and heater 418 may be shut off, and the valves may be closed (710).

The beverage dispenser 410 of the illustrated embodiment is also capable of rinsing the brewing chamber 420 and flow passages 426. This may allow the system to rinse away residual materials from prior beverages. The beverage dispenser 410 may be configured to automatically and/or manually rinse the system. For example, the dispenser 410 may be configured to rinse the system automatically each time the beverage formula is changed. As another example, the dispenser 410 may be configured to automatically rinse the system if a specified period of time passes since the last beverage was prepared. With reference to FIG. 7B, the brewing chamber 420 may be rinsed by opening valves 428a and 428d, closing valve 428b and engaging pump 416 for the desired period of time. When it is desirable to rinse the flow passage from the brewing chamber to the beverage outlet, the system may open valves 428a and 428b, close valve 428d and engage the pump 416.

In this embodiment, the beverage dispenser 410 may also be capable of dispensing water (heated or unheated). To discharge water, valve 428a is closed, valve 428c is opened and pump 416 is engaged. The heater 418 may also be turned on if heated water is desired.

As noted above, the foregoing description of operation of the beverage dispenser 410 was made with reference to the embodiment shown in FIG. 7B. The design and configuration of the beverage dispenser may, however, vary from application to application, and the method and manner of implementing different brewing steps or brewing procedures may vary in accordance with those variations. For example, as described above, beverage dispenser 10 of FIG. 7A varies from the beverage dispenser 410 of FIG. 7B in that it includes an extra valve 28e. This extra valve allows hot water to be dispensed from the dispenser through the drain without passing through the brewing chamber 20. This may be useful when it is desired to provide clean hot water, for example, for rinsing a pot or a cup. The beverage dispenser 10 may otherwise be operated in a manner that is essentially identical to the beverage dispenser 410 of FIG. 7B.

### TCM Formulas—Tests and Testing Methodologies

In the illustrated embodiment, the beverage dispenser 10 is configured to brew a wide variety of beverages, including coffee beverages and various TCM herbal teas. To facilitate the preparation of TCM herbal teas, the ingredients for a select variety of different TCM herbal teas are available in specially configured pods. In one embodiment, TCM herbal tea pods include ingredients for the following beverages: fire removal drink, damp-heat eliminator drink, beauty builder drink, fresh formula drink and kidney nourishment drink. The number and type of TCM formulations available for use in the beverage dispenser may vary from application to application. The following paragraphs provide some specifications relating to the test and testing methods used to develop TCM herbal tea pods for use with the beverage dispenser 10. The process is described in connection with the fire removal formula, but it should be understood that the process could be implemented in connection with essentially any other TCM formula, such as the formulas for damp-heat eliminator drink, beauty builder drink, fresh formula drink and kidney nourishment drink.

A. Benchmark. In China and other Asian countries, there are a lot of people that drink TCM herbal teas. Generally speaking, TCM herbal teas are prepared manually by immersing the TCM herbal tea ingredients in a cup with hot water and waiting until a tolerant temperature to drink, and then refill the cup 3-5 times in one day. In developing the beverage dispenser of the present invention, a variety of tests were performed to assess the performance of the beverage dispenser compared with manual brewing and to determine optimal beverage preparation parameters. The first round of tests were run to determine the benchmark against which to compare variations in preparation parameters. More specifically, tests were run to assess the extract weights achieved using conventional manual brewing procedures. Given that soaking time may vary in manual brewing and that the variations may impact the total extract weight over multiple soaking events, a number of tests were performed using different soaking times. For this test, the fire removal formula (Table 1) for TCM herbal tea was tested. The test method involved the steps of placing the original pieces in 300 ml boiled water in flask to imitate the drinking habit, wait until it is cooled to room temperature, filter the extract fluid, and then repeating the process twice. In determining extract weight, the extractions were concentrated and dried, the dried extracts from all three repetitions were combined and the combined extracts were weighed to determine the total extract, which is the benchmark.

TABLE 1
Fire Removal Formula

| Ingredients | Used part | Dosage(g/serving) | Feedstock form |
|---|---|---|---|
| Honeysuckle | flower | 1 | Original pieces |
| Lily | bulb | 1.5 | Original pieces |
| Platycodon | root | 0.5 | Original pieces |
| Peppermint | leaf | 0.5 | Original pieces |

To reduce the deviation, a number of parallel experiments were run and the results of the parallel experiments were averaged to provide the results shown in Table 2.

TABLE 2
Fire Removal Formula: Experiment Time and Result.

| Experiment | Soaking time (min) | Extract weight (g) |
|---|---|---|
| Soaking the first time | 45 min | 0.7 |
| Soaking the second time | 45 min | 0.1 |
| Soaking the third time | 45 min | 0 |
| Total | | 0.8 |

In the first test, the original pieces were placed in boiled water and allowed to soak for 45 min, which is a natural cooling to room temperature time. To consider other soaking times, which may correspond to different consumer brewing/drinking habits, additional test where run with 30-minute soakings (Table 3) and 15-minute soakings (Table 4).

TABLE 3
Fire Removal Formula: Experiment Time and Result.

| Experiment | Soaking time (min) | Extract weight (g) |
|---|---|---|
| Soaking the first time | 30 min | 0.6 |
| Soaking the second time | 30 min | 0.2 |
| Soaking the third time | 30 min | 0 |
| Total | | 0.8 |

TABLE 4
Fire Removal Formula: Experiment Time and Result.

| Experiment | Soaking time (min) | Extract weight (g) |
|---|---|---|
| Soaking the first time | 15 min | 0.5 |
| Soaking the second time | 15 min | 0.3 |
| Soaking the third time | 15 min | 0 |
| Total | | 0.8 |

Benchmark is soaking the formula 45 minutes by repeating 15 minute soakings three times in total. The beverage resulting from each soaking is concentrated and dried, and the resulting extract is weighed. In each test, the total extract weight after three soakings was the same, namely 0.8 grams. For the fire removal formula defined in Table 1, the benchmark using standard brewing methods is 0.8 g/45 min.

B. Process Parameters Design

i. Particle Size. It was hypothesized that reduced particle size would help the extract ratio, meanwhile the particle size can't be too small because it might block the pipeline. To test this hypothesis, test were run with three different particle sizes, namely 7-20 mesh, 20-40 mesh, and 40-60 mesh, and the resulting extract weights were compared.

The tests were run using a prototype machine capable of operating for different periods of time at different pressures and different temperatures. For this test, the prototype machine was operated in the 5-min mode/100° C. to obtain extract from 3 g/300 ml ingredients of different particle sizes. With these tests, the honeysuckle, lily, platycodon and peppermint where tested separately. The tables 5-8 are the extract experiment results.

TABLE 5
Lily different particle size extract experiment result.

| Lily | Extract mode | Extract weight (g) |
|---|---|---|
| Original pieces | 3 g/300 ml/5 min/100° C. | 0.5 |
| 7-20 mesh | 3 g/300 ml/5 min/100° C. | 0.8 |
| 20-40 mesh | 3 g/300 ml/5 min/100° C. | 1.1 |
| 40-60 mesh | 3 g/300 ml/5 min/100° C. | 1.4 |

TABLE 6
Platycodon different particle size extract experiment result.

| Platycodon | Extract mode | Extract weight (g) |
|---|---|---|
| Original pieces | 3 g/300 ml/5 min/100° C. | 1.0 |
| 7-20 mesh | 3 g/300 ml/5 min/100° C. | 1.6 |
| 20-40 mesh | 3 g/300 ml/5 min/100° C. | 1.7 |
| 40-60 mesh | 3 g/300 ml/5 min/100° C. | 1.8 |

TABLE 7
Honeysuckle different particle size extract experiment result.

| Honeysuckle | Extract mode | Extract weight (g) |
|---|---|---|
| Original pieces | 3 g/300 ml/5 min/100° C. | 0.7 |
| 7-20 mesh | 3 g/300 ml/5 min/100° C. | — |
| 20-40 mesh | 3 g/300 ml/5 min/100 | — |
| 40-60 mesh | 3 g/300 ml/5 min/100 | — |

TABLE 8
Peppermint different particle size extract experiment result.

| Peppermint | Extract mode | Extract weight (g) |
|---|---|---|
| Original pieces | 3 g/300 ml/5 min/100° C. | 0.6 |
| 7-20 mesh | 3 g/300 ml/5 min/100° C. | — |
| 20-40 mesh | 3 g/300 ml/5 min/100° C. | — |
| 40-60 mesh | 3 g/300 ml/5 min/100° C. | — |

Lily and platycodon tests were run using parts of the root, stem and/or bulb. The material quality is hard. The extract results of the tests at different particle size demonstrate that decreased particle size can increase the extract ratio. But for 7-20 mesh, 20-40 mesh and 40-60 mesh, since the particle size is too small, a lot of herb particles can go through the pipeline system. There are lots of visible herbal particle deposits in the extract liquid. For the next steps of the experiment, particle size of 7-20 mesh was used.

Honeysuckle and peppermint tests were run using the flower and/or leaf/stem. The material quality is soft and easily inflatable after absorbing water. As a result, decreased particle size can block the pipeline system. For the next steps of the experiment, original ingredients pieces were used.

ii. Extract Time. To evaluate the extract time of unit, to unit efficiency, a series of tests were performed using different extract times, more specifically, separate tests were performed using 2 min, 2.5 min, 3 min and 5 min extract time, with 100° C. as extract temperature. Tests were performed using formulations with different particle sizes. The Group I tests were performed using ingredients pieces as the extract ingredient material (Table 9). The Group II tests were performed using honeysuckle and peppermint ingredients pieces and using lily and platycodon with a particle size of 7-20 mesh as the extract ingredient material (Table 10). Tables 9 and 10 show the different time/extract experiment result.

TABLE 9
Group I - Time/Extract Experiment Result (Ingredient Pieces)

| Fire Removal Formula | Extract weight (g) |
|---|---|
| 2 min | 0.3 |
| 2.5 min | 0.4 |
| 3 min | 0.5 |
| 5 min | 0.6 |

According to the result for the Group I tests, increasing the extract time results in increasing the extract ratio. However, the Group I experiments using the original ingredient pieces and even the prototype machine operating in 5 min mode/0.6 g did not meet the benchmark total 0.8 g, but did meet the benchmark for first time extract of 0.5 g (See Table 4).

TABLE 10
Group II Time/Extract Experiment Result (Honeysuckle And Peppermint
Ingredients Pieces, Lily And Platycodon 7-20 Mesh).

| Fire Removal Formula | Extract weight (g) |
|---|---|
| 2 min | 0.8 |
| 2.5 min | 0.9 |
| 3 min | 1.1 |
| 5 min | 1.2 |

According to the results for the Group II tests, increasing the extract time results in increasing the extract ratio. Further, since the experiment uses honeysuckle and peppermint ingredients pieces, and uses lily and platycodon with a particle size of 7-20 mesh as the extract ingredient materials, the prototype machine operating in any mode between 2 min-5 min can meet or exceed the benchmark.

iii. Extract Temperature. A series of tests were also performed to test the impact in changes to extract temperature. To assess unit efficiency at different temperatures, tests were performed at 50° C., 70° C., 80° C., 90° C. and 100° C. as extract temperature. These tests were performed using honeysuckle and peppermint ingredients pieces, and lily and platycodon with a particle size of 7-20 mesh as the extract ingredient material. Table 11 is the different temperature extract experiment result. As can be seen, an increase in temperature results in an increase in extract weight through the range of temperatures tested.

TABLE 11
Temperature Extract Experiment Result

| Temperature | Extract weight (g) |
|---|---|
| 50° C. | 0.8 |
| 70° C. | 1.0 |
| 80° C. | 1.1 |
| 90° C. | 1.1 |
| 100° C. | 1.2 |

iv. Extract Pressure. A series of tests were performed to assess the impact of extract pressure on extract yield. According to unit efficiency, tests were performed at 1.0 bar, 1.1 bar, 1.5 bar, 2.0 bar, 2.5 bar, 3.0 bar, 3.5 bar, 4.0 bar and 5.0 bar as extract pressure. For these tests, the ingredients were provided with a particle size of 20-40 mesh as the extract ingredient material. Table 12 is the different pressure extract experiment results. As can be seen, increased pressure generally resulted in increased extract weight.

TABLE 12
Pressure Extract Experiment Result

| | Extract |
|---|---|
| Fire Removal | weight |
| Formula | (g) |
| 1 bar | 0.9 g |
| 2.0 bar | 1.0 g |
| 3.0 bar | 1.1 g |
| 3.5 bar | 1.1 g |
| 4.0 bar | 1.1 g |
| 5.0 bar | 1.2 g |
| 6.0 bar | 1.2 g |
| 7.0 bar | 1.2 g |
| 8.0 bar | 1.2 g |

Additionally, a number of tests were performed to assess the effect of combined changes in temperature and pressure on the extraction of Chrysanthemum. The test results are presented in table 13 below.

TABLE 13
Temperature and Pressure Experiment Result

| Experiment | Experiment | Extract | Extract |
|---|---|---|---|
| temperature | pressure | time | ratio |
| (° C.) | (MPa) | (min) | (%) |
| 95 | 0.085 | 30 | 18.2 |
| 110 | 0.14 | 30 | 21.3 |
| 120 | 0.20 | 30 | 22.7 |

From the experiment result, there is clear evidence that the higher pressure and temperature can enhance the extraction ratio of Chrysanthemum.

Further tests were performed to assess the effect of temperature and pressure changes on the extraction of coffee. The results of those tests are presented below in table 14.

TABLE 14
Temperature and Pressure Experiment Result

| Experiment | Experiment | Extract | Extract |
|---|---|---|---|
| temperature | pressure | time | ratio |
| (° C.) | (MPa) | (min) | (%) |
| 98 | 0.095 | 60 | 24.1 |
| 145 | 0.42 | 60 | 32.3 |
| 180 | 1.00 | 60 | 45.4 |

From the experiment result, there is clear evidence that the higher pressure and temperature can enhance the extraction ratio of coffee.

C. Pre-Brewing Modes.

The brewing process may include one or more pre-brewing steps that are intended primarily to improve extract rate. These pre-brewing steps may be implemented, as desired, in the production of a beverage to reduce the overall brewing time required to obtain a particular extract rate. The parameters (e.g. temperature, pressure and time) of each pre-brewing step may vary from formula to formula. For example, different ingredients may react differently to the potential pre-brewing steps, and the determination of which pre-brewing step(s) (if any) and the parameters of the selected pre-brewing step(s) may be arrived at through testing.

i. Steam Pre-Soaking. Steam pre-soaking is carried out by injecting steam or heated water into the brewing chamber. Typically, the heater will be engaged to bring the water to the desired temperature and then the pump will be engaged to move the heated water into the brewing chamber. It may be beneficial to cycle the pump on and off and/or to operate it at a reduced duty cycle to allow the heater to keep the water at the desired temperature. The water is held in the brewing chamber for a predetermined period of time. Although referred to as steam pre-soaking, the water moved into the brewing chamber need not be steam. Rather, this step may be implemented using liquid water. This may be particularly true in applications where water is moved into the brewing chamber at an elevated pressure.

ii. Cold Water Pre-Soaking. Cold water pre-soaking is carried out by injecting water into the brewing chamber without heating. Typically, the pump will be engaged to move the water from the tank into the brewing chamber. The unheated water is held in the brewing chamber for a predetermined period of time. The cold water pre-soaking may be particularly useful in producing unheated teas or other unheated beverages. Although this step may be implemented without heating the water, it may in some applications be desirable to heat the water to a relatively low temperature. This will allow the cold water pre-soaking step to be carried out under essentially uniform temperatures, which may yield a more consistent extract rate from beverage to beverage.

iii Steam Softening. Steam softening is implemented by moving steam or heated water through the brewing chamber. Unlike the soaking steps discussed above, steam softening is carried out with the brewing chamber open to the drain or the beverage outlet. As a result, the steam or heated water continuously passes through the ingredients. Typically, the heater will be engaged to bring the water to the desired temperature and then the pump will be engaged to move the heated water through the brewing chamber to the drain (or to the beverage outlet). As with steam soaking, it may be beneficial to cycle the pump on and off and/or to operate it at a reduced duty cycle to allow the heater to keep the water at the desired temperature. Although referred to as steam softening, the water moved through the brewing chamber need not be steam, but may instead be liquid water.

### Principles of TCM Formula Design

The present invention is configured to be particularly well-suited for use in brewing TCM herbal teas. The type and variety of TCM herbal teas that may be produced by the dispenser 10 may vary from application to application. In the illustrated embodiment, the beverage dispenser 10 is configured to brew five different TCM herbal teas, though this number may vary over time by adding or removing TCM herbal tea formulations. Each of the formulas for these five TCM herbal teas is constituted with the herbal ingredients and formulas founded with and supported by the theory of traditional Chinese medicine. All the herbal ingredients in these formulas are permitted to be used in general food by China FDA and have organic resources. The TCM formulas are targeted at Chinese people's most common health concerns and are intended to bring corresponding health benefit to them. The epidemiological surveys reported that the damp-heat, qi-deficiency and blood stasis are all the most common health concerns and the most common so-called unhealthy constitutions from the viewpoint of TCM. The syndrome of excessive internal heat affects a very significant portion of Chinese people. One epidemiological survey reported that over 90% of the Chinese people have been subject to this health problem.

A. Fire Removal Formula.

This formula is designed to help people against what TCM refers to as “excessive internal heat.” According to TCM theory, excessive internal heat often brings health problems such as: 1. Dry mouth and nose, feel thirsty to drink. 2. Halitosis, sore throat, swollen gums, festered mouth and oral ulcer.

What is the “excessive internal heat” and how it harms our body health? According to TCM theory, “excessive internal heat” is a kind of excessive internal heat that causes body fluid impairment, presents dry mouth and nose, and thirst, etc. And, according to TCM theory, the fire-poison leaks out to the exterior and manifests in bad breath, sore throat, swollen gums, festered mouth and oral ulcer.

Thus, according to TCM theory, to fight against these problems, the key is to clear the fire and soothe the throat.

TABLE 15
Detailed information of Fire Removal Formula.
Formula 1

| | TCM linked | | Rationality for the formula |
|---|---|---|---|
| | property and | Formula | design by the TCM theory |
| Ingredients | flavor | constitution | support |
| Honeysuckle | warm in | Honeysuckle 6 g, | Honeysuckle, with a cold nature, clears heat, |
| | nature, | Lily 10 g, | relieves the excessive internal fire and |
| | pungent | Platycodon 3 g, | helps the body to expel interior heat. Its role |
| lily | slightly cold, | Peppermint 3 g. | focus on “Clear the Fire”. Lily, with a |
| | sweet | The dose is the | cold nature, nourishes the Lung-Yin. Its |
| platycodon | Neutral | daily upper limit, | role focus on“Water restricts Fire”. |
| | (neither warm | which is | Platycodon grandiflorus, with a median |
| | nor cold), | suggested to | nature, makes Lung-Qi descend, resolves |
| | bitter, pungent | fine-tuned in | phlegm, discharges pus, and soothes the |
| peppermint | cool, | proportion | throat; Peppermint, with a cold nature, |
| | pungent | according to the | soothes the throat, promotes eruption |
| | | volume of pods | and relieves poison. The combination of |
| | | and daily use | Platycodon grandiflorus and peppermint can |
| | | frequency. | eliminate throat and oral symptoms caused |
| | | | by the Fire. So their roles emphasize |
| | | | on“Soothe the Throat”. |

B. Damp Heat Eliminator Formula.

This formula is designed to help people against what TCM theory refers to as “damp-heat,” which TCM often associates with health problems such as: 1) Multiple skin problems such as a rash or acne and 2) Poor appetite and heavy sensation as if the head were wrapped. 3. Deep yellow urine and pudendum moist.

What is internal “dampness” and how it happens and harms our body health? According to TCM theory, “dampness” is an internal condition that could be caused by dysfunctions of spleen and stomach induced by high-fat foods, insufficient sleep and lack of exercises, manifesting with a poor appetite. Internal “dampness” also results in the curbing of the lucid Yang, manifesting with the heavy sensation as if the head were wrapped. Internal “dampness” also blocks the channels and meridians, leading to the skin dystrophy. The accumulation of the “dampness” in the body is easy to transfer to internal “heat” resulting in “damp-heat.” When damp-heat invades the body surface, it induces the inflammation and brings about acnes and rashes. When damp-heat stagnates in the body surface, it results in pudendum moist and heat. When excessive damp-heat is moved out of the body, it manifests with deep-colored urine and much leucorrhea, while the exclusion is stagnated, it leads to unsmooth of emiction. More colloquially, “damp-heat” is like body “junk,” so the deep-colored urine and female leucorrhea are manifested with when they are expelled from the body. If this garbage is retained in the body and reach the skin, many skin problems, such as acne may result.

Therefore, according to TCM theory, to fight against the health problems produced by the “damp-heat”, the key is to expel dampness, eliminate heat-poison and strengthen the spleen.

TABLE 16
Detailed information Damp Heat Eliminator Formula.
Formula 2

| | TCM linked | | Rationality for the formulas |
|---|---|---|---|
| | property | Formula | design by the TCM theory |
| ingredients | and flavor | constitution | support |
| coix seed | cool, sweet | Coix seed 10 g, | Coix seed, Dandelion, and Semen |
| dandelion | cold, bitter, | Dandelion 9 g | Euryales clear the Dampness in |
| semen | neutral, sweet, | Semen Euryales | the body. They are the “The Cure”. |
| euryales | astringent, | 9 g, Cordate | Coix seed also clears heat which |
| cordate | slightly | houttuynia 15 g. | is generated along with the |
| houttuynia | cold, pungent. | The dose is the | dampness, playing the role |
| | | daily upper limit, | of “Expel the Heat”. Semen |
| | | which is suggested | Euryales tonifies the kidney, |
| | | to fine-tuned in | strengthens the Essence and arrests |
| | | proportion | leucorrhea which bothers women, |
| | | according | playing the role of “Expel the |
| | | volume of pods | to the Damp”. Cordate houttuynia |
| | | and daily use | resolves Fire-Poison, discharges |
| | | frequency. | profuse pus and has diuretic effect. |
| | | | Its diuretic effect could help the |
| | | | remove of the Damp-heat out of |
| | | | the body. |

C. Beauty Builder Formula.

This formula is designed to help people against what TCM refers to as “blood-stasis,” which TCM associates with health problems such as: 1. Sallow complexion without luster and rough, dry skin with crusts. 2. Easily been subject to food retention in the stomach. 3. Dull skin and dark spots on the face.

Under TCM theory, “blood stasis” results from weakness of the spleen and the stomach, as well as nutritional deficiency. This impairs the transformation and transportation of blood, which results in a sallow complexion with dry and rough skin because the skin lacks nourishment and moistening by the “blood” due to the blood stasis.

Due to the food retention in the stomach, the Qi-blood stagnancy in the body is produced which manifests in the body surface with the melanin deposit in the skin and also allows food to be retained in the stomach more easily.

“Blood-stasis” more often happens to women during the menstrual cycle, manifesting itself with sallow complexion and melanin deposit in the skin, etc. Therefore, the spleen and stomach should be strengthened to help nutrition more easily absorbed and improve the transformation and transportation of blood.

So, to fight against these health problems produced by the “blood stasis”, TCM theories indicate that the key is to promote the blood circulation and smoothen the channels and collaterals to help the elimination of the food retention in the stomach and blood-qi stagnancy, as well as to nourish the Spleen-Yin.

TABLE 17
Detailed information of Beauty Builder Formula.
Formula 3

| | TCM linked | | Rationality for the formulas |
|---|---|---|---|
| | property and | Formula | design by the TCM theory |
| ingredients | flavor | constitution | support |
| Rhizoma | Neutral, sweet | Rhizoma | Rhizoma Dioscoreae nourishes |
| Dioscoreae (yam) | | Dioscoreae | Qi and Yin, as well as the |
| Seabuckthorn fruit | Warm, acerbity, | 10 g, Sea | Spleen, thus promoting the |
| | stringent | Buckthorn 3 g, | transformation and |
| Hawthorn | Slightly warm, | Hawthorn 10 g, | transportation of blood, through |
| | acerbity, sweet | Radix | its effect of “Tonify”. Sea |
| Radix Puerariae | Cool, sweet, pungent | Puerariae 9 g. | Buckthorn and Hawthorn |
| | | The dose is the | promotes digestion and |
| | | daily upper | dissolves food accumulation |
| | | limit, which is | and the blood stasis. So their |
| | | suggested to | effect emphasizes on |
| | | fine-tuned in | “Eliminate”. Radix Puerariae |
| | | proportion | smoothens the channels and |
| | | according to | collaterals, thus making it |
| | | the volume | of easier to resolve food retention |
| | | pods and daily | and blood stasis. So its effect |
| | | use frequency. | emphasizes on“Smoothen”. |

D. Fresh Formula.

This formula is designed to help people address what TCM refers to as “Qi-deficiency and mental fatigue,” which TCM often associates with syndromes like: always tired, in poor mental state and low work efficiency, easily distracted and always sleepy.

According to TCM, Qi-deficiency is caused by congenital weakness or nutrition deficiency due to the lung, spleen, and stomach disorders. Otherwise, it also can be the result of overtiredness, internal injury or a long illness. According to TCM, Qi is the source of spirit (Shen), and the impairment of Qi results in impairment of spirit (Shen). Therefore, Qi-deficiency leads to poor mental state, in which people often feel tired and sleepy.

So, to fight against these health problems, the key is to tonify the Qi and lift the spirit.

TABLE 18
Detailed information of Fresh Formula.
Formula 4

| | TCM | | |
|---|---|---|---|
| | linked | | Rationality for the formulas |
| | property | Formula | design by the TCM theory |
| ingredients | and flavor | constitution | support |
| Polygonatum | Neutral, | Polygonatum | Polygonatum sibiricum Red. |
| sibiricum | sweet | sibiricum Red. | tonifies the Kidney-Qi and |
| Red. | | 10 g, wolfberry | the Spleen-Qi; Wolfberry |
| wolfberry | Neutral, | fruit 10 g, Green | fruit tonifies the Liver-Qi |
| | sweet | tea 3 g, | and the Kidney-Qi; the |
| Peppermint | Cool, | Peppermint 3 g. | combination has a |
| | pungent, | The dose is the | synergistic effect on |
| Green tea | Slightly | daily upper limit, | ”tonify the Qi”. |
| | cold, | which is | Green tea clears upwards |
| | sweet, | suggested to | towards the eye and head, |
| | bitter. | fine-tuned in | playing the role of “Lift the |
| | | proportion | Spirit”. Peppermint benefits |
| | | according to the | the throat and refreshes the |
| | | volume of pods | breath, helpful to mental |
| | | and daily use | refreshment. |
| | | frequency. | |

E. Kidney Nourishment Formula.

This formula is designed to help people address what TCM refers to as “Qi-deficiency and Premature Aging.” According to TCM, Qi-deficiency and premature aging often manifests symptoms such as: 1. Listlessness and fatigue, weak back and knees, less energetic. 2. Dim eyesight, eyestrain. 3. Spontaneous perspiration, polyuria, and easily subject to diarrhea. 4. Premature grey hair.

According to TCM theory, “Premature Aging” is caused by Kidney-Qi deficiency or congenital weakness. Otherwise, it also can be the result of overtiredness, internal injury or nutrition deficiency and postnatal deficiency. Because the Kidney dominates the muscles and bones, manifests in the hair, and stores the Essence (Jing), so the Kidney-Qi deficiency results in cold limbs, weak back and knees. Due to the “Qi deficiency”, the energy is impaired manifesting with listless and fatigue, the hair loses the nourishment and turns grey and the Essence (Jing) can't be properly stored and guarded which results in the symptoms such as spontaneous perspiration, polyuria, easily subject to diarrhea and prospermia.

So, to fight against these health problems in accordance with TCM theory, the key is to tonify the kidney-Qi and guard the Essence.

TABLE 19
Detailed information of Kidney Nourishment Formula.
Formula 5

| | TCM linked | | Rationality for the formula |
|---|---|---|---|
| | property | Formula | design by the TCM theory |
| ingredients | and flavor | constitution | support |
| Polygonatum | sweet, neither | Polygonatum | Polygonatum sibiricum Red. and |
| sibiricum Red. | cold nor warm | sibiricum Red. | wolfberry fruit tonify and nourish |
| wolfberry | sweet, neither | 10 g, wolfberry | the Kidney-Qi and solve the |
| | cold nor warm | fruit 10 g, | problem of “Premature |
| Raspberry | Sweet, acerbity, | Raspberry 6 g, | Aging” through “Tonify”. In |
| | warm. | Semen | addition, Polygonatum sibiricum |
| Semen | Sweet, acerbity, | Nelumbinis 6 g. | Red. also benefits the Spleen-Qi, |
| Nelumbinis | neither warm nor | The dose is the | helps the transformation and |
| (lotus seed) | cold. | daily upper limit, | transportation of water and food |
| | | which is | and promotes the nutrition uptake, |
| | | suggested to | which in turn elevates the Kidney- |
| | | fine-tuned in | Qi. Raspberry and Semen |
| | | proportion | Nelumbinis benefit the kidney and |
| | | according to the | guard the Essence (Jing), through |
| | | volume of pods | the “uptake & store essence” |
| | | and daily use | assists in solving the problems of |
| | | frequency. | spontaneous perspiration, polyuria, |
| | | | easily been diarrhea and |
| | | | prospermia. Wolfberry fruit and |
| | | | Raspberry also nourish the liver |
| | | | and brighten the eyes, resolving the |
| | | | problems of dim eyesight and |
| | | | eyestrain. |

It has been determined that improved brewing can be achieved by providing TCM ingredients with optimal particles sizes, and by controlling the time, pressure and temperature of the brewing process. Additional improvements may be achieved by pre-soaking the ingredients. The follow table provides the brewing parameters for the Fire Removal formula in one embodiment of the present invention. The brewing parameters for other TCM formulas may be determined using the methodology set forth herein. This includes but is not limited to brewing parameters for the damp-heat eliminator formula, the beauty builder formula, the fresh formula and the kidney nourishment formula.

| | | Particle | | | |
|---|---|---|---|---|---|
| Formula | Ingredient | Size | Time | Temp | Pressure |
| Fire | Honeysuckle | 7-60 | 2-5 | 50° C.-100° C. | 1.0-8.0 |
| Removal | Lily | mesh | mins. | | bar |
| | Platycodon | | | | |
| | Peppermint | | | | |

Preparation and production of the fire removal formula will now be described in connection with the beverage dispense of FIG. 7A. In this embodiment, a beverage pod is provided with the desired volume (e.g. by weight) of honeysuckle, lily, platycodon and peppermint in the desired particle sizes. In this embodiment, the ingredients are provided in the following approximate weights: honeysuckle 6 g, lily 10 g, platycodon 3 g and peppermint 3 g. The weights of each ingredient and formula are approximate and may be reduced and increased, as desired. For example, the various weights may vary in accordance with the Chinese Pharmacopoeia of Traditional Chinese Medicines. Although these are principle ingredients of the fire removal formula, it should be understood that other ingredients can be added according to the user's need. For example, additional nutritional supplements or flavor additives may be included in the pod, if desired. The ingredients may then be washed. In this embodiment, the ingredients may be washed 2-3 times in pure cold water. The ingredients are then allowed to dry.

After the ingredients have dried, they are milled to the desired particle size. In the illustrated embodiment, all of the ingredients are milled to the same particle size, but the different ingredients may be milled to a different size, if desired. In the illustrated embodiment, all of the ingredients are milled to 7-20 mesh. The particle size may, however, vary from application to application. For example, the ingredients may be milled to 20-40 mesh or 40-60 mesh. In other alternative embodiments, the particles may be milled to 7-60 mesh. Although finer particle sizes can increase extract rate, smaller particles can creating clogging issues within the beverage dispenser. So, it may be helpful to consider the design and configuration of the beverage dispenser before making a final determination on particle size. With beverage dispenser more susceptible to clogging by fine particles, it may be beneficial to utilize larger particle sizes. The ingredients may be milled separately or simultaneously. The milled ingredients are then thoroughly mixed, as desired.

The ingredients are then packaged in the appropriate beverage pod. Although the pod of the illustrated embodiment may be a plastic cup with a tab containing product identifying information. The ingredients may be packaged in other types of containers, such as a packet that can be dumped into the brewing chamber or into a refillable pod or a nylon bag that be placed directly into the brewing chamber (similar to a tea bag).

The following paragraphs describe the process of brewing the fire removal drink using the beverage dispenser described above. At the outset, the fire removal ingredients (e.g. the pod or other container) are loaded into the beverage dispenser (for example, into the brewing chamber) and the beverage dispenser is set to extract under the 5 min mode at 100° C. and 5.0 bar. These parameters may vary from application to application. For example, the brewing time, temperature and/or pressure may be varied to adjust the preparation time and extract rate. In some applications, it may be desirable to shorten brewing time at the expense of a lower extract rate. In other applications, it may be desirable to adjust one brewing parameter to account for changes in another brewing parameter. For example, it may be desirable to increase brewing pressure and/or temperature in an effort to yield the same extract rate with a reduced brewing time.

The beverage dispenser then implements a steam softening step that is intended to try to soften the ingredients and expand the material to increase surface area. In this embodiment, the steam softening step will last about 50 s, but the time may vary from application to application. The steam softening step includes the steps of: (a) turning on the heating element; (b) at or about the same time, opening valve 26a and 26d and closing valve 26b and 26c close; (c) turning on the pump for about 2 s; (d) stopping the pump and waiting for about 15 s; (e) turning on the pump for about 10 ms; (f) turning off the pump for about 100 ms; (g) repeating steps (e) and (f) about 300 times; and (h) turning off the heating element. It should be understood that the times and number of repetitions are approximate and that these values may vary from application to application.

Following the steam soak step, the beverage dispenser may implement a pressure hold step. The purpose of the pressure hold step is to soak the material under high pressure to try to increase extraction in the following flush (or extraction) step. This step of the process will take about 80 s as described, but the duration of this step may be varied from application to application. The steam soak step of this embodiment includes the steps of: (a) closing valve 26b, 26c and 26d, and opening valve 26a; (b) turning on the pump for about 3 s; (c) closing valve 26a for about 15 s; (d) turning on both valve 26a and the pump for 0.5 s; (e) turning off both valve 26a and pump for about 6 s; (f) repeating step (e) about 10 times. The times and number of repetitions associated with the steam soak step are approximate and that these values may vary from application to application.

After the ingredients have been soaked in the pressure hold step, the beverage dispenser implements a water flush step. The purpose of this step is to obtain extract from the various ingredients. This step will take about 30 s in the described embodiment, but the duration of this step may be varied from application to application. The water flush step of this embodiment includes the steps of: (a) opening valve 26a and 26b, and closing valve 26c and 26d; (b) turning off the pump and turning on the heating element for about 30 ms; (c) turning on the pump and turning off the heating element for about 70 ms; (d) repeating steps (b) and (c) about 100 times; (e) turning off the heating element; (f) turning on the pump for about 10 ms; (g) turning off the pump for about 90 ms; and repeating steps (f) and (g) about 50 times.

To increase the amount of extract obtained from the ingredients and/or to increase the volume of the produced drink, the beverage dispenser may repeat one or more of the previous steps. In this embodiment, the beverage dispenser next repeats both the pressure hold step and the water flush step. After repeating those two steps, the beverage dispenser may repeat the water flush step one last time. When this is done, the beverage is ready for consumption. The number of times that the pressure hold step and water flush step are performed may vary from application to application depending on various factors, such as the desired amount of extract or the desired drink volume.

Although the preceding method of producing the fire removal beverage includes identified particle size, time, pressure and temperature values (or ranges of values), it should be understand that those values may be varied from application to application. For example, the values may be varied in producing the fire removal beverage using alternative methods or they may be varied in producing different TCM beverages. To illustrate this variability, the particle size distribution for this embodiment may be 7-60 mesh, 7-20 mesh, 20-40 mesh or 40-60 mesh. These different particle size distributions can result in higher extract weight and use less time than the benchmark process, which uses original piece. Experience has revealed that 20-40 mesh and 40-60 mesh get the better extract weight results, but since the particle size is relatively fine, it may potentially cause clogging issues. It may be possible to address the clogging issues by taking precautions in the design of the beverage dispenser. Experience has revealed that 7-20 mesh is an optimum particle size parameter for the fire removal beverage produced in accordance with the method described above. The time of the brewing process for this embodiment may vary from 2-5 minutes. For example, the TCM beverages may be produced in brewing processes that take 2 min, 2.5 min, 3 min or 5 min. All of these time parameters can speed up the formula extraction process. Experience has revealed that 5 min is an optimum time parameter for production of the fire removal formula, which can meet the benchmark first time extract. Temperature may vary from 50-100° C. for this embodiment. Experience has revealed that brewing at a temperature of 50° C., 70° C., 80° C., 90° C. and 100° C. can meet the benchmark. It has been determined that 100° C. get the highest extract weight, which is an optimum temperature parameter. Pressure for this embodiment may vary from 1.0-8.0 bar. Brewing pressures of 1.0 bar, 2.0 bar, 2.5 bar, 3.0 bar, 3.5 bar, 4.0 bar, 5.0 bar, 6.0 bar, 7.0 bar and 8.0 bar have been demonstrated to meet the benchmark. Experience has revealed that 5.0 bar achieves the highest extract weight, which is an optimum pressure parameter. The brewing pressure may be increased, for example, to 6.0-8.0 bar, in applications where the beverage dispenser is capable of operating at elevated pressures. It is anticipated that increased brewing pressure will yield higher extract weight.

It has been determined that improved brewing can be achieved by providing TCM ingredients with optimal particles sizes, and by controlling the time, pressure and temperature of the brewing process. Additional improvements may be achieved by pre-soaking the ingredients. The brewing parameters for the various TCM formulas in one embodiment of the present invention may be essentially identical to the brewing parameters discussed above in connection with the fire removal formula. For example, the particle size distribution of the various ingredients for the damp-heat eliminator drink, beauty builder drink, fresh formula drink and kidney nourishment drink may be in the range of 7-60 mesh. Ingredients with particle size distributions in the range 20-40 mesh and 40-60 mesh may provide improved extraction rates, but in some beverage dispensers may have the potential to create clogging. With those beverage dispensers, ingredients with a particle size distribution of 7-20 mesh may be used. In use, however, the particle size distribution and associated brewing parameters for the various TCM formulas may vary. To facilitate these variations, the particle size distribution or related information may be contained in the information made available in the pod. The beverage dispenser may use this information to obtain the appropriate brewing parameters (e.g. temperature, pressure and time) for each brewing step. These brewing parameters may be maintained in one or more look-up tables within the beverage dispenser or in a network device that is accessible to the beverage dispenser. Alternatively, the pod information may include the brewing parameters so that they need not be obtained from a separate look-up table. For example, the pod may include information that specifies the pre-brewing and brewing steps, and also specifies the brewing parameters for each of those steps.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A beverage dispenser for producing a plurality of different types of beverages provided in a disposable beverage container comprising:
a brewing chamber configured to receive the beverage container;
a pump configured to pump water into said brewing chamber;
a heater configured to heat water pumped to said brewing chamber;
an information system for obtaining beverage information relating to the beverage from the beverage container; and
a controller capable of setting a plurality of brewing parameters as a function of said beverage information, said plurality of brewing parameters including brewing pressure, brewing temperature and brewing time.

2. The beverage dispenser of claim 1 wherein said controller controls said brewing pressure by varying on/off time of said pump.

3. The beverage dispenser of claim 1 wherein said controller controls said brewing temperature by varying on/off time of said heater.

4. The beverage dispenser of claim 1 wherein said information system includes an optical sensor system capable of sensing presence or absence of apertures in a portion of said container.

5. The beverage dispenser of claim 4 wherein said optical sensor system includes a light source disposed on one side of said portion of said container and a plurality of light sensors disposed on an opposite side of said portion of said container.

6. The beverage dispenser of claim 5 wherein said beverage information is a beverage type, said controller obtaining said brewing parameters as a function of said beverage type.

7. The beverage dispenser of claim 6 wherein said controller includes a brewing parameter look-up table containing brewing parameters, said beverage type being a key to said brewing parameters.

8. The beverage dispenser of claim 7 wherein the beverage container includes a tab, said portion being further defined as a portion of said tab.

9. The beverage dispenser of claim 8 wherein said beverage information includes a validation code, said controller configured to recognize a counterfeit beverage container based on said validation code.

10. The beverage dispenser of claim 1 wherein said information system is capable of reading one or more user-adjustable data bits, said controller configured to customize the beverage as a function of said user-adjustable data bits.

11. A beverage dispenser configured for use with a network of remote devices comprising:
a brewing chamber for brewing a plurality of different types of beverages, said plurality of different types of beverages including different ingredients; and
a user assistance system for providing beverage recommendations, said user assistance system including a communication system for obtaining user information and for communicating with at least one remote device in the network of remote devices, at least one of said remote devices configured to provide said communication system with network information relevant to said beverage recommendation, said network information based on information obtained from a plurality of remote devices, said user assistance system including a controller capable of providing said beverage recommendation as a function of said user information and said network information.

12. The beverage dispenser of claim 11 wherein said communication system is configured to obtain information from a personal device associated with a user.

13. The beverage dispenser of claim 11 wherein said user information includes information regarding a user's diet and exercise.

14. The beverage dispenser of claim 13 wherein said network information is representative of historical information obtained from a plurality of remote devices over time, said historical information being reflective of an efficacy of prior beverage recommendations.

15. The beverage dispenser of claim 14 wherein said user information include information relevant to a health status of the user.

16. The beverage dispenser of claim 11 further including a beverage additive system for introducing beverage additives into a beverage formula, said user assistance system capable of including beverage additives in said beverage recommendation.

17. The beverage dispenser of claim 16 wherein said beverage additives includes nutritional supplements.

18. The beverage dispenser of claim 17 wherein said plurality of different types of beverages includes a plurality of different traditional Chinese medicine herbal teas.

19. The beverage dispenser of claim 11 wherein said user information includes information indicative of whether the user consumed a recommended beverage and information indicative of an efficacy of a recommended beverage.

20. The beverage dispenser of claim 19 wherein said user assistance system includes a user interface configured to allow said beverage dispenser to solicit and receive at least a portion of said user information from the user.

21. The beverage dispenser of claim 20 wherein said network of remote devices includes a plurality of devices that obtain information relating to physical activity of the user, consumption activities of the user and sleep activities of the user.

22. The beverage dispenser of claim 21 wherein said user assistance system includes a controller capable of generating said beverage recommendation based on said user information and said network information.

23. The beverage dispenser of claim 22 wherein said user assistance system communicates said user information to at least one of said remote devices, whereby said user information may incorporated into said network information.

24.-54. (canceled)
